(19) United States
(12) Patent Application Publication
(10) Pub. No.: US 2017/0275129 A1
(43) Pub. Date: Sep. 28, 2017

(54) BINDING DEVICE

(71) Applicant: MAX CO., LTD., Tokyo (JP)

(72) Inventor: Hiroaki TAKAHASHI, Tokyo (JP)

(73) Assignee: MAX CO., LTD., Tokyo (JP)

(21) Appl. No.: 15/510,800

(22) PCT Filed: Sep. 16, 2015
(86) PCT No.: PCT/JP2015/076367

§ 371 Date: Mar. 13, 2017

(30) Foreign Application Priority Data
Sep. 30, 2014 (JP) 2014-201663

(51) Int. Cl. B65H 37/04; B65H 3/44; B42C 11/02; B42C 1/12

(52) U.S. Cl. CPC B65H 37/04; B42C 1/12; B65H 3/44; B42C 11/02; B42D 3/002

(57) ABSTRACT

This compact binding device is such that binding operations can be carried out when the main body of the device is held. The binding device (1A) is provided with a cassette storage unit (60A) in which a cassette (8) can be detachably attached, said cassette housing an elongate tape (5) which has a piece (2) adhered thereto and is wound into a roll. The cassette housing unit (60A) is provided at the bottom of the device main body (110A), which comprises a base unit (11A) and a handle unit (12), and the cassette (8) does not protrude rearwards from the handle unit (12) and the base unit (11A).

### TECHNICAL FIELD

The present invention relates to a binding device configured to bind a sheet bundle with a piece made of an easily bendable non-metal material having a thin foil shape such as paper, resin or the like.

### RELATED ART

A device configured to bind a sheet bundle such as documents with a member referred to as a piece made of paper or the like, not a metal needle, has been known.

As the device, a technology has been suggested in which a cassette configured to accommodate therein a long disposable having the piece bonded to the disposable is attached at the rear of a device main body (refer to Patent Documents 1, 2 and 3). In such the device, a sheet bundle is penetrated with a cutting blade, the piece is held with the cutting blade, the piece is inserted into the sheet bundle by an operation of inserting and pulling out the cutting blade into and from the sheet bundle.

Also in a device where a configuration for penetrating the sheet bundle and a configuration for binding the sheet bundle with the piece are separately provided, the cassette having the disposable accommodated therein is attached at the rear of the device main body (refer to Patent Document 4).

### CITATION LIST

### Patent Documents

Patent Document 1: Japanese Patent Application Publication No. H10-871A
Patent Document 2: Japanese Patent No. 3,122,807B
Patent Document 3: Japanese Patent Application Publication No. 2003-25753A
Patent Document 4: Japanese Patent Application Publication No. H10-24669A

SUMMARY

### Problems To Be Solved

For example, as disclosed in Patent Document 1, Patent Document 2 and Patent Document 3, according to the configuration where the storage unit configured to store therein the disposable is provided at the rear of the device main body, the storage unit, the cassette to be mounted to the storage unit, and the like protrude from the rear of the device main body. In the configuration where the sheet bundle is bound with the piece, since the disposable of which a plurality of sides is bonded to a long release paper is supplied with being wound into a roll shape, a space for accommodating therein the disposable becomes large. For this reason, in the configuration where the storage unit configured to accommodate therein the disposable, the cassette to be mounted to the storage unit, and the like protrude from the rear of the device main body, a size of the device main body in a front and rear direction increases, so that a wide operation space is required.

Also, in Patent Document 1, Patent Document 2 and Patent Document 3, it is difficult to perform the binding operation with gripping the device main body. Particular, in Patent Document 1, Patent Document 2 and Patent Document 3, the device is configured to perform the binding by straightly pushing down a pressing handle, a pushing-down member or a pushing-down part in an upper and lower direction, without the assumption that the binding operation is performed with gripping the device main body.

Also, regarding the device configured to perform the binding by straightly pushing down the pressing handle, the pushing-down member or the pushing-down part in the upper and lower direction, as disclosed in Patent Document 1, Patent Document 2 and Patent Document 3, a device having an operation handle configured to rotate about a shaft serving as a support point has been also suggested, as disclosed in Patent Document 4. However, the device is a large-scale device capable of performing the binding at two places at the same time, so that it is difficult to perform the binding operation with gripping the device main body.

The present invention has been made in view of the above situations, and an object thereof is to provide a small-scale binding device capable of performing a binding operation with gripping a device main body.

### Means for Solving Problems

In order to solve the above problems, the present invention is a binding device comprising a device main body comprising a base unit, on which a sheet bundle is to be placed, and an operation member, a cutting blade configured to penetrate the sheet bundle by an operation of the operation member and to insert a piece into the sheet bundle, a storage unit configured to store therein a disposable of which a plurality of pieces is bonded to a long release paper, and a conveying unit configured to convey the disposable pulled out from the storage unit, wherein the storage unit is provided at a part of the device main body in front of or at a rear of a gripping part of the operation member.

The present invention is a binding device comprising, a device main body comprising a base unit, on which a sheet bundle is to be placed, and an operation member, a cutting blade configured to penetrate the sheet bundle by an operation of the operation member and to insert a piece into the sheet bundle, a storage unit configured to store therein a disposable of which a plurality of pieces is bonded to a long release paper, and a conveying unit configured to convey the disposable pulled out from the storage unit, wherein the storage unit is provided at a part of the device main body, which faces a gripping part of the operation member via the sheet bundle, which is to be placed on the base unit, being interposed therebetween.

The present invention is a binding device comprising a device main body comprising a base unit, on which a sheet bundle is to be placed, and an operation member, a cutting blade configured to penetrate the sheet bundle by an operation of the operation member and to insert a piece into the sheet bundle, a storage unit configured to store therein a disposable of which a plurality of pieces is bonded to a long release paper, and a conveying unit configured to convey the disposable pulled out from the storage unit, wherein the storage unit is provided at a part of the device main body, which is in front of or at a rear of a first gripping part of the operation member or a second gripping part of the base part.

### Effects of the Invention

According to the present invention, the storage unit of the disposable is provided at the part of the device main body, in front of or at the rear of the gripping part of the operation member. Therefore, it is possible to grip the device main body without any difficulty in gripping the gripping part of the operation member and to perform the operation with gripping the device main body.

Also, according to the present invention, since the storage unit of the disposable is provided at the part of the device main body, which faces the gripping part of the operation member via the sheet bundle, which is to be placed on the base unit, being interposed therebetween, it is possible to make the device main body smaller. Also, it is possible to grip the device main body without any difficulty in gripping the gripping part of the operation member and to perform the operation with gripping the device main body.

Also, according to the present invention, the storage unit of the disposable is provided at the part of the device main body, in front of or at the rear of the first gripping part of the operation member or the second gripping part of the base unit. Therefore, it is possible to grip the device main body without any difficulty in gripping the first gripping part of the operation member or the second gripping part of the base unit and to perform the operation with gripping the device main body.

### BRIEF DESCRIPTION OF DRAWINGS

FIG. 1 is a configuration view depicting an example of a binding device in accordance with a first embodiment.

FIG. 2 is a configuration view depicting an example of the binding device in accordance with the first embodiment.

FIG. 3 is a configuration view depicting an example of a piece having bound a sheet bundle.

FIG. 4 is a configuration view depicting an example of the piece.

FIG. 5 is a perspective view depicting a driving mechanism of a cutting blade.

FIG. 6 illustrates an open and closed state of a cassette storage unit.

FIGS. 7A to 7E illustrate an outline of an operation of binding a sheet bundle with the piece.

FIG. 8 illustrates an example of an operation of the binding device in accordance with the first embodiment.

FIG. 9 illustrates an example of the operation of the binding device in accordance with the first embodiment.

FIG. 10 illustrates an example of the operation of the binding device in accordance with the first embodiment.

FIG. 11 illustrates an example of the operation of the binding device in accordance with the first embodiment.

FIG. 12 illustrates an example of the operation of the binding device in accordance with the first embodiment.

FIG. 13 illustrates an example of the operation of the binding device in accordance with the first embodiment.

FIG. 14 is a configuration view depicting an example of a binding device in accordance with a second embodiment.

FIG. 15 illustrates an open and closed state of a cassette storage unit.

FIG. 16 is a configuration view depicting a modified embodiment of the binding device in accordance with the second embodiment.

FIG. 17 is a configuration view depicting another modified embodiment of the binding device in accordance with the second embodiment.

FIG. 18 is a configuration view depicting an example of a binding device in accordance with a third embodiment.

FIG. 19 is a configuration view depicting an example of the binding device in accordance with the third embodiment.

FIG. 20 is a configuration view depicting an example of a binding device in accordance with a fourth embodiment.

FIG. 21 is a configuration view depicting an example of the binding device in accordance with the fourth embodiment.

FIG. 22 is a configuration view depicting a modified embodiment of the binding device in accordance with the fourth embodiment.

FIG. 23 is a configuration view depicting the modified embodiment of the binding device in accordance with the fourth embodiment.

FIG. 24 is a configuration view depicting an example of a binding device in accordance with a fifth embodiment.

FIG. 25 is a configuration view depicting an example of the binding device in accordance with the fifth embodiment.

FIG. 26 is a configuration view depicting a modified embodiment of the binding device in accordance with the fifth embodiment.

FIG. 27 is a configuration view depicting the modified embodiment of the binding device in accordance with the fifth embodiment.

FIG. 28 is a configuration view depicting an example of a binding device in accordance with a sixth embodiment.

FIG. 29 is a configuration view depicting an example of a binding device in accordance with a seventh embodiment.

FIG. 30 is a configuration view depicting an example of the binding device in accordance with the seventh embodiment.

FIG. 31 is a configuration view depicting an example of a binding device in accordance with an eighth embodiment.

FIG. 32 is a configuration view depicting an example of the binding device in accordance with the eighth embodiment.

FIG. 33 illustrates a modified embodiment of the cassette.

### DETAILED DESCRIPTION OF EMBODIMENTS

Hereinafter, embodiments of the binding device of the present invention will be described with reference to the drawings.

### Configuration Example of Binding Device of First Embodiment

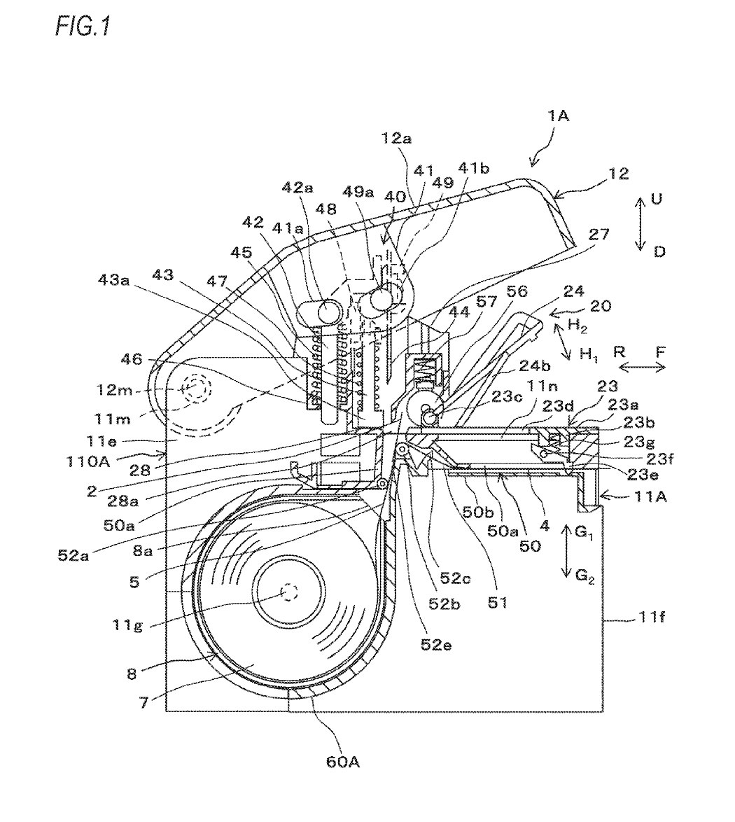

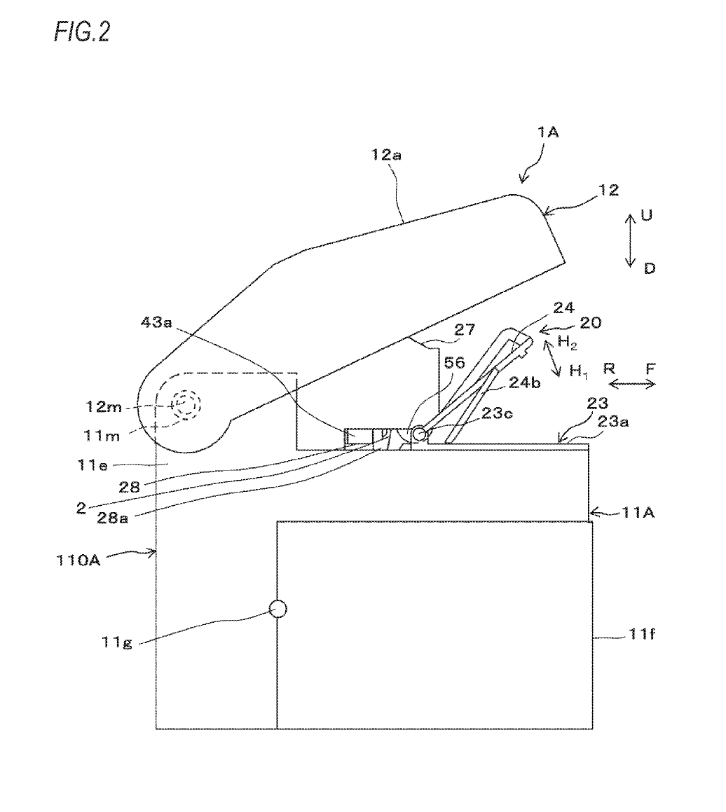

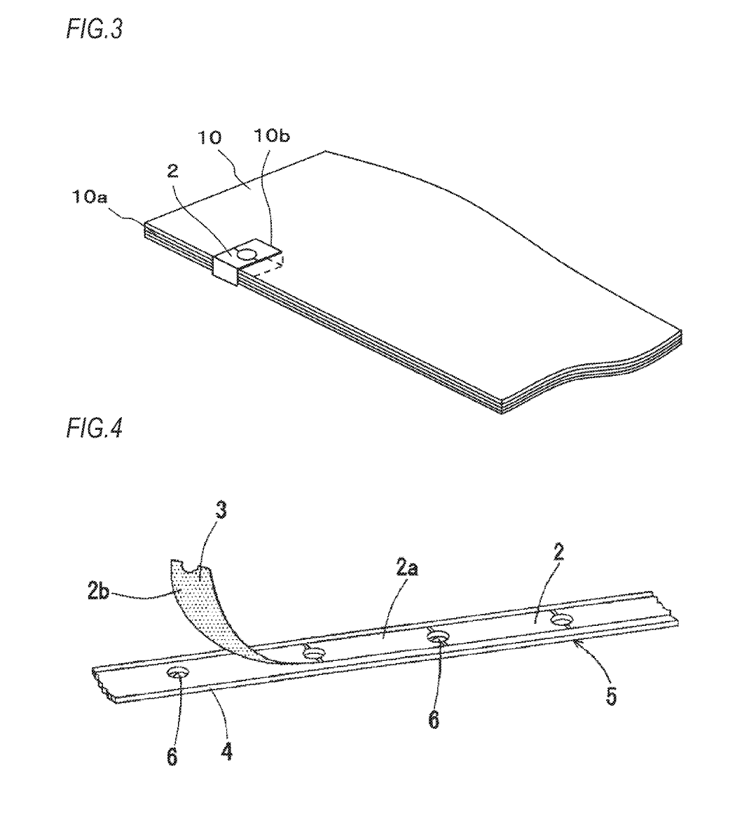

FIGS. 1 and 2 are configuration views depicting an example of a binding device in accordance with a first embodiment. Here, FIG. 1 depicts an internal configuration of a binding device 1A, and FIG. 2 depicts an external configuration of the binding device 1A. Also, FIG. 3 is a configuration view depicting an example of a piece having bound a sheet bundle, and FIG. 4 is a configuration view depicting an example of the piece.

First, a piece and a sheet bundle, which are processing targets of the binding device 1A, are described. As shown in FIG. 3, the binding device 1A of the first embodiment is a device configured to bind a sheet bundle 10 by winding a piece 2, which is a disposable, to the sheet bundle 10 having a plurality of stacked sheets. The sheet bundle 10 is formed by stacking sheets such as documents, sheet-like members formed of a metal or resin material, and the like.

One side of the piece 2 is wound from a lower surface, which is one surface of the sheet bundle 10, to an end portion 10a -side of the sheet bundle 10. Also, the other side of the piece 2 is wound through a through-hole 10b formed in the sheet bundle 10. The respective end portions of the piece 2 are bonded to an upper surface, which is the other surface of the sheet bundle 10, so that the piece binds the sheet bundle 10.

As shown in FIG. 4, the piece 2 has a rectangular shape, for example. One surface 2a of the piece 2 is a planar surface, and the other surface 2b is provided with an adhesive layer 3. A plurality of the pieces 2 is temporarily bonded to a long release paper 4 in a longitudinal direction, for example. Thereby, even when the piece is used after it has been left for a long time, it is possible to prevent an adhesive force of the adhesive layer 3 from being lowered. Also, the piece 2 is made of an easily bendable non-metal material having a thin foil shape.

Also, a tape 5 consisting of the piece 2 and the release paper 4 is wound into a roll shape and is accommodated in the binding device 1A, as a roll body, for example. The piece 2 and the release paper 4 are formed with a plurality of engaging holes 6, in which a mechanism configured to convey the tape 5 is to be engaged, with a predetermined interval in the longitudinal direction.

Subsequently, a configuration of the binding device 1A is described. The binding device 1A is configured to preliminarily shape the piece 2 by relative movement between the sheet bundle 10 and the piece 2 resulting from movement of the sheet bundle 10. As shown in FIGS. 1 and 2, the binding device includes a base unit 11A and a handle unit 12 configured to be rotatable relative to the base unit 11A. Also, the binding device 1A includes a holding unit 20 configured to hold and move the sheet bundle 10, which is a binding target, a binding unit 40 configured to shape the piece 2 in corporation with the holding unit 20 and to bind the sheet bundle 10 with the piece 2, a conveyor unit 50 as an example of the piece conveyor unit configured to convey the tape 5 in corporation with the holding unit 20, and a cassette storage unit 60A to which a cassette 8 having a roll body 7 of the tape 5 accommodated therein is to be detachably mounted.

The handle unit 12 is an example of the operation member. A shaft 12m provided at one end portion-side of the handle unit 12 is engaged with a shaft support part 11m provided at one end portion-side of the base unit 11A. Thereby, the handle unit 12 is attached to the base unit 11A so that one end portion-side thereof can rotate about the shaft 12m, which is a support point, and the other end portion-side becomes a free end. The handle unit 12 is provided with a gripping part 12a for gripping and operating the binding device 1A. When operating the binding device 1A, it is possible to operate the same with gripping the gripping part 12a.

The binding device 1A is configured so that when the free end-side of the handle unit 12 is operated, the handle unit 12 is rotated about the shaft 12m serving as a support point and the rotating operation of the handle unit 12 is transmitted to the binding unit 40 to operate the binding unit 40, as described later.

Herein, a using aspect that the binding device 1A is used with being placed on a desk or the like is assumed. In below descriptions, a side at which the base unit 11A is provided is defined as a lower side in an upper and lower direction, such as a lower surface, a lower side, a downward side and the like, and a side at which the handle unit 12 is defined as an upper side in the upper and lower direction, such as an upper surface, an upper side, an upward side and the like. Also, the free end-side of the handle unit 12 is defined as a front side in a front and rear direction, such as a front surface, a front side, a forward side and the like, and a side at which the shaft 12m is defined as a rear side in the front and rear direction, such as a rear surface, a rear side, a rearwards side and the like.

The base unit 11A has a main frame body 11e and a lower frame body 11f. The base unit 11A is provided with the shaft support part 11m at a rear and upper part of the main frame body 11e. Also, the base unit 11A is attached with the lower frame body 11f to be rotatable about a shaft 11g provided at a rear and lower part of the main frame body 11e and serving as a support point. The base unit 11A is configured so that when the lower frame body 11f is rotated in an arrow J₁ direction and an arrow J₂ direction, the lower frame body 11f is opened rearwards and a lower part of the base unit 11A is opened and closed. In addition, the base unit 11A has a movement support part 11n configured to moveably support the holding unit 20 and provided at the main frame body 11e.

The movement support part 11n is provided at a front and upper surface-side of the base unit 11A with facing the free end-side of the handle unit 12 and is configured as a groove part provided along the front and rear direction and configured to guide movement of the holding unit 20 in an arrow F direction and an arrow R direction.

Subsequently, the holding unit 20 is described. The holding unit 20 is an example of the placement unit, is attached to a front and upper surface of the base unit 11A so as to be moveable in the front and rear direction by the movement support part 11n, and is configured to be moveable between an inserting/drawing position of the sheet bundle 10 located below the free end-side of the handle unit 12 and a binding position located below the binding unit 40.

The holding unit 20 includes a tray 23 on which the sheet bundle 10, which is a binding target, is to be placed, and a pushing member 24 rotatably attached to the tray 23 and configured to push the sheet bundle 10 to the tray 23 by a rotation operation.

In the meantime, as described later, since the holding unit 20 relates to a partial preliminary shaping of an operation of once winding the piece 2 to the sheet bundle 10, the holding unit configures the preliminary shaping unit. Also, since the holding unit 20 relates to a part of an operation of conveying the tape 5, the holding unit configures the conveying unit.

In the first embodiment, the tray 23 is configured to have a rectangular flat plate shape in conformity to the shape of the base unit 11A, and has a placement part 23a on which the sheet bundle 10 is to be placed, and an engaging guide part 23b to be engaged with the movement support part 11n of the base unit 11A. The engaging guide part 23b has a shape protruding downwards from a lower surface of the placement part 23a, and is configured to engage with the movement support part 11n of the base unit 11A. Thereby, the holding unit 20 can move between the inserting/drawing position and the binding position as the engaging guide part 23b is guided to the movement support part 11n.

Also, the holding unit 20 is provided with a rotary shaft 23c configured to rotatably support the pushing member 24 at a rear end portion of the placement part 23a. In addition, a rear end-side of the placement part 23a is provided with a cutout part 23d having a rectangular shape at a substantial center in a width direction. The cutout part 23d is configured by providing the placement part 23a with an opening, in which the piece 2 configured to bind the sheet bundle 10 and a cutting blade 44 (which will be described later) of the binding unit 40 can be introduced when the holding unit 20 is moved to the binding position, while avoiding the adhesion position of the piece 2.

The holding unit 20 has a holding claw 23e configured to hold the release paper 4. The holding claw 23e is an example of the conveying unit, is provided at the engaging guide part 23b with facing a conveyance path of the release paper 4, and moves in the arrow F direction and the R direction when the holding unit 20 moves. The holding claw 23e is configured to be rotatable by a rotation operation about a shaft 23f serving as a support point, which is provided at an upstream side with respect to the conveying direction in which the release paper 4 is to be drawn out, and is urged in the direction of the release paper 4 by a spring 23g.

When the holding claw 23e is moved in the arrow R direction by an operation of moving the holding unit 20 from the inserting/drawing position to the binding position, the holding claw rotates about the shaft 23f serving as a support point in an arrow G₁ direction, against the spring 23g, and retreats from the conveyance path of the release paper 4. Thereby, the holding claw is not engaged with the engaging hole 6 of the release paper 4, so that the tape 5 and the release paper 4 are not reversely conveyed by the operation of moving the holding unit 20 from the inserting/drawing position to the binding position.

In the meantime, when the holding claw 23e is moved in the arrow F direction by an operation of moving the holding unit 20 from the binding position to the inserting/drawing position, the holding claw rotates about the shaft 23f serving as a support point in an arrow G₂ direction by a force of the spring 23g and protrudes into the conveyance path of the release paper 4. Thereby, the holding claw 23e is engaged with the engaging hole 6 of the release paper 4, so that the tape 5 and the release paper 4 are drawn out by the operation of moving the holding unit 20 from the binding position to the inserting/drawing position.

The pushing member 24 is rotatably supported at a rear end-side by the rotary shaft 23c, and is configured to rotate in an arrow H₁ direction and an arrow H₂ direction with respect to the tray 23, thereby opening and closing a front side of the tray 23. The pushing member 24 is made of an elastic material, and elastic pieces 24b of which a front side is configured as a base end are integrally provided.

The elastic pieces 24b are provided by two members protruding from the pushing member 24 so that they are positioned at right and left sides of the cutout part 23d of the placement part 23a. A rear end-side of the elastic piece is a free end and is bent towards the tray 23. The elastic pieces 24b are contacted at rear ends thereof to the tray 23 and are configured to raise and keep the entire pushing member 24.

In the meantime, regarding the tray 23 and the pushing member 24 configuring the holding unit 20, the pushing member 24 is provided so that a binding position of the sheet bundle 10 is not to deviate from the tray 23. When the binding position of the sheet bundle 1 is set not to deviate from the tray 23 upon a binding operation, the pushing member 24 is not necessarily provided.

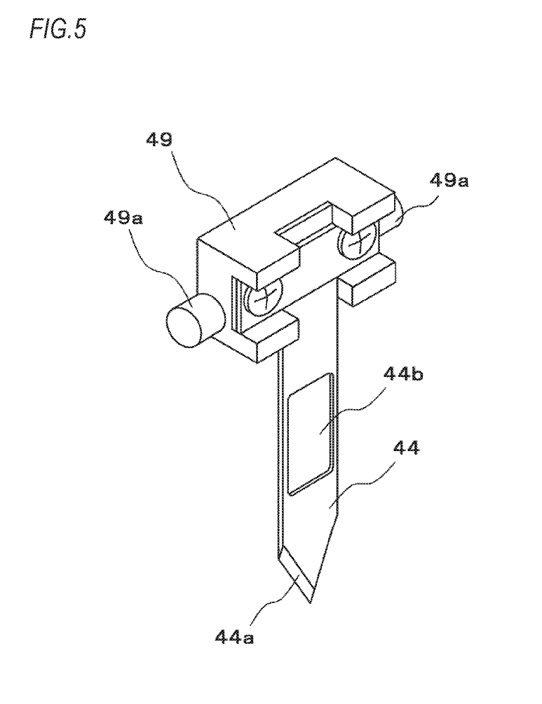

FIG. 5 is a perspective view depicting a driving mechanism of the cutting blade. In the below, a mechanism configured to operate the binding unit 40 and the cutting blade 44 by the handle unit 12 is described with reference to the respective drawings.

The binding unit 40 has a driving member 41 provided on an inner and lower surface of the handle unit 12. Also, the binding unit 40 has a guide lever 42 configured to move in an upper and lower direction by displacement of the driving member 41, a pressing lever 43 configured to press the piece 2 configured to bind the sheet bundle 10, and a cutting blade 44 configured to penetrate the sheet bundle 10, which are provided in a component arranging part 27.

The component arranging part 27 is integrally provided with the base unit 11A, and an entrance groove 28 in which the holding unit 20 moving to the binding position is to be introduced is provided on a moving path of the holding unit 20. Also, the component arranging part 27 and the base unit 11A have a piece standby part 28a at which the piece 2 released from the release paper 4 is to stand by and which is provided on a moving path of the sheet bundle 10 held by the holding unit 20 to be inserted into the entrance groove 28. The entrance groove 28 is an opening provided with being spaced between the base unit 11A and the component arranging part 27. When the holding unit 20 is introduced into the entrance groove, the pushing member 24 is pressed in an arrow H₁ direction of coming close to the tray 23, so that the sheet bundle 10 is interposed and held between the tray 23 and the pushing member 24. The holding unit 20, the entrance groove 28 and the pressing lever 43 configure the preliminary shaping unit configured to preliminarily shape the piece 2 by the relative rotation between the sheet bundle 10 and the piece 2 resulting from the movement of the holding unit 20.

The binding unit 40 has the pressing lever 43 and the cutting blade 44, which are provided above the entrance groove 28, and the driving member 41 configured to transmit the movement of the handle unit 12 to the pressing lever 43 via the cutting blade 44 and the guide lever 42 and having first guide holes 41a and second guide holes 41b. The first guide hole 41a is configured as a long hole and a convex portion 42a of the guide lever 42 is engaged thereto. The second guide hole 41b is configured as a long hole and a convex portion 49a of an attaching member 49 (FIG. 5) having the cutting blade 44 attached thereto is engaged to the second guide hole.

When the free end-side of the handle unit 12 is operated and the handle unit 12 is thus rotated about the shaft 12m serving as a support point, positions of the first guide hole 41a and the second guide hole 41b of the driving member 41 are displaced in the upper and lower direction. Thereby, the rotation of the handle unit 12 linearly moves the guide lever 42 in the upper and lower direction. Also, the cutting blade 44 is linearly moved in the upper and lower direction.

The guide lever 42 is configured so that it is to be guided and moved in the upper and lower direction by the component arranging part 27. In the guide lever 42, an elastic member such as a coil spring 45 is wound and inserted. The coil spring 45 configures a so-called return spring of the handle unit 12, and a lower end portion thereof is received at the base unit 11A by a receiving part 46 of the component arranging part 27. Also, an upper end portion of the coil spring 45 is received at the handle unit 12 by the convex portion 42a of the guide lever 42 engaged to the first guide hole 41a of the driving member 41.

Thereby, the handle unit 12 is urged in an arrow U direction of separating from the base unit 11A by the coil spring 45. Also, when the handle unit 12 is pushed in an arrow D direction, the coil spring 45 is contracted and the guide lever 42 is linearly moved in the arrow D direction. Herein, the first guide hole 41a is configured as a long hole, so that the convex portion 42a can move along the first guide hole 41a of which a locus of displacement is a circular arc shape about the shaft 12m and the guide lever 42 is linearly moved without a locus of displacement of the convex portion 42a forming into a circular arc shape.

The pressing lever 43 is provided in front of the guide lever 42. The pressing lever 43 has a pressing part 43a configured to press and bond the piece 2 to the sheet bundle 10. The pressing lever 43 is wound with a pressing spring 47 consisting of an elastic member such as a coil spring. The pressing spring 47 has one end engaged to the pressing part 43a and the other end engaged to the moving member 48 configured to move in conjunction with the guide lever 42.

The cutting blade 44 is provided in front of the pressing lever 43. As shown in FIG. 5, the cutting blade 44 is formed with an insertion hole 44b, which is provided above a blade part 44a and the piece 2 is to be inserted therein. The cutting blade 44 is attached to the attaching member 49, and the attaching member 49 is connected to the guide lever 42.

At a state where the handle unit 12 is at a standby position, the blade part 44a of the cutting blade 44, which is provided at a tip end, does not protrude downwards from the entrance groove 28. A height and a moving amount of the blade part 44a are set so that when the handle unit 12 is pressed in the arrow U direction, the blade part penetrates the sheet bundle 10 pressed by the pressing part 43a of the pressing lever 43.

As shown in FIG. 5, the convex portions 49a protrude laterally from right and left sides of the attaching member 49 having the cutting blade 44. Each convex portion 49a is engaged to the second guide hole 41b of the driving member 41. Herein, the second guide hole 41b is configured as a long hole, so that the convex portion 49a can move along the second guide hole 41b of which a locus of displacement is a circular arc shape about the shaft 12m and the cutting blade 44 is linearly moved without a locus of displacement of the convex portion 49a forming a circular arc shape.

According to the binding unit 40 configured as described above, when the handle unit 12 is pressed down in the arrow D direction, the handle unit 12 is rotated above the shaft 12m serving as a support point in the arrow D direction, so that the convex portions 49a configured to drive the cutting blade 44 by the second guide holes 41b of the driving member 41 are pressed and the cutting blade 44 is thus moved in the arrow D direction. Thereby, the cutting blade 44 penetrates the sheet bundle 10.

Also, when the handle unit 12 is pushed up in the arrow U direction, the handle unit 12 is rotated above the shaft 12m serving as a support point in the arrow U direction, so that the convex portions 49a configured to drive the cutting blade 44 by the second guide holes 41b of the driving member 41 are pushed up and the cutting blade 44 is thus moved in the arrow U direction. Thereby, the cutting blade 44 having penetrated the sheet bundle 10 is pulled out. During the pulling-out operation of the cutting blade 44, the piece 2 held by the cutting blade 44 is pulled out to the surface-side of the sheet bundle 10, in succession to the cutting blade 44, as described later.

Subsequently, a pressing roller 56 configuring a part of the binding unit 40 is described. The pressing roller 56 is provided in front of the cutting blade 44. The pressing roller 56 is urged downwards by an elastic member such as a coil spring 57, and presses the piece 2 having bound the sheet bundle 10 when the holding unit 20 is moved between the binding position and the inserting/drawing position.

Subsequently, the conveyor unit 50 and the cassette storage unit 60A are described. The conveyor unit 50 is an example of the conveying unit, and has a first guide configuring member 50a provided at the main frame body 11e of the base unit 11A and a second guide configuring member 50b provided at the lower frame body 11f with facing the first guide configuring member 50a, which members configure a conveyance path 51 of the tape 5 before the piece 2 to be carried by the operation of the holding unit 20 is to be released and the release paper 4 from which the piece 2 has been released.

The conveyor unit 50 has a first roller 52a configured to guide the tape 5 pulled out from the cassette 8 accommodated in the cassette storage unit 60A and a second roller 52b configured to face more downwards than a horizontal direction on the conveyance path of the tape 5 at a downstream side of the first roller 52a, and configures a bent conveyance path. Also, the conveyor unit 50 has an engaging claw 52c configured to hold the release paper 4 and a retreat part 52d configured to retreat the release paper 4 held with the engaging claw 52c.

The first roller 52a of the conveyor unit 50 is provided at the first guide configuring member 50a. Also, the second roller 52b and the engaging claw 52c of the conveyor unit 50 are provided at the second guide configuring member 50b. In addition, the retreat part 52d of the conveyor unit 50 is configured in a space between the first guide configuring member 50a and the second guide configuring member 50b.

The conveyor unit 50 is configured to bend the conveyance path to an acute angle by the second roller 52b, thereby configuring a release part 52e configured to release the piece 2 from the tape 5 by using rigidness of the piece 2. In the conveyor unit 50, the tape 5 pulled out from the cassette 8 accommodated in the cassette storage unit 60A is conveyed upwards with being guided to the first roller 52a. Then, the tape 5 is guided to the second roller 52b and is bent to an acute angle. The release paper 4 is bent to an acute angle at the release part 52e, so that only the piece 2 temporarily attached to the release paper 4 travels straight upwards and the piece 2 is straightly released by about a half from the release paper 4 without being bent. The piece 2 released from the release paper 4 waits for the sheet bundle 10 with the adhesive layer 3 shown in FIG. 4 facing towards the sheet bundle 10 that is being introduced with being held by the holding unit 20. The release paper 4 downstream of the second roller 52b is conveyed to the front of the base unit 11A and is discharged.

The engaging claw 52c is provided downstream of the second roller 52b, protrudes to the conveyance path 51 with being inclined forward, and is engaged with the engaging hole 6 of the release paper 4. The retreat part 52d is configured by providing a space, in which the release paper 4 is to be introduced, at a position facing the engaging claw 52c.

When the holding unit 20 is moved from the inserting/drawing position to the binding position, the holding claw 23e is moved in the arrow R direction and the tape 5 and the release paper 4 are thus applied with a force in a reverse conveying direction, the engaging claw 52c is engaged with the engaging hole 6 of the release paper 4, so that the tape 5 and the release paper 4 are not reversely conveyed.

On the other hand, when the holding unit 20 is moved from the binding position to the inserting/drawing position, the holding claw 23e is moved in the arrow F direction and the tape 5 and the release paper 4 are thus applied with a force in a forward conveying direction, the engaging claw 52c is disengaged from the engaging hole 6 of the release paper 4, the release paper 4 is introduced into the retreat part 52d and the tape 5 and the release paper 4 can be conveyed in the forward direction. When the force of conveying the release paper 4 is not applied, the engaging hole 6 of the release paper 4 is engaged with the engaging claw 52c.

The cassette storage unit 60A is an example of the storage unit, and is provided at a lower part of the device main body 110A having the base unit 11A and the handle unit 12. The cassette storage unit 60A is provided at a rear and lower part of the base unit 11A, in the first embodiment. In the cassette 8 to be accommodated in the cassette storage unit 60A, the roll body 7 of which the tape 5 is wound in an involution form where the surface having the piece 2 bonded thereto faces towards an inner side is accommodated, and the tape 5 is to be pulled out from a drawing port 8a.

In the cassette storage unit 60A, the cassette 8 is accommodated in a vertical direction so that a circumferential direction of the roll body 7 becomes a vertical direction, and the tape 5 pulled out from the drawing port 8a of the cassette 8 is guided to the conveyance path 51 from the lower part of the conveyor unit 50. In the first embodiment, an external shape of the cassette 8 is configured so that it does not protrude rearwards beyond the rear end of the handle unit 12.

The cassette storage unit 60A is provided at a part of the device main body 110A, which is at the rear of the gripping part 12a of the handle unit 12, i.e., at the base unit 11A in the first embodiment. Also, the cassette storage unit 60A is provided at a part facing the cutting blade 44 with the sheet bundle 10, which is to be placed as described later by the holding unit 20, being interposed therebetween. Also, the cassette storage unit 60A is provided at a part of a side at which the drawing port 8a of the cassette 8 faces the cutting blade 44 via the conveyor unit 50 being interposed therebetween. Also, the cassette storage unit 60A is provided at a part of a side that faces the gripping part 12a of the handle unit 12 via the sheet bundle 10, which is to be placed by the holding unit 20, being interposed therebetween.

The cassette 8 is accommodated in the cassette storage unit 60A so that the drawing port 8a is positioned just below the conveyance path reaching the release part 52e, i.e., so that the drawing port 8a faces upwards, in the first embodiment, and a part at which the tape 5 is to be pulled out from the drawing port 8a is provided below the conveyance path 51. Thereby, the conveyance path from the drawing port 8a to the release part 52e is substantially linear.

The release part 52e is configured to bend the conveyance path to an acute angle with the second roller 52b, thereby releasing the piece 2 from the tape 5 by using the rigidness of the piece 2. The conveyance path reaching the release part 52e is made to be linear, so that the load is reduced upon the conveying of the tape 5 and the release paper 4.

In the cassette storage unit 60A, the accommodation position of the cassette 8 is set in conformity to the position of the shaft 11g of the lower frame body 11f. Thereby, the cassette storage unit is opened and closed by the rotation operation of the lower frame body 11f about the shaft 11g serving as a support point.

### Operation Example of Binding Device of First Embodiment

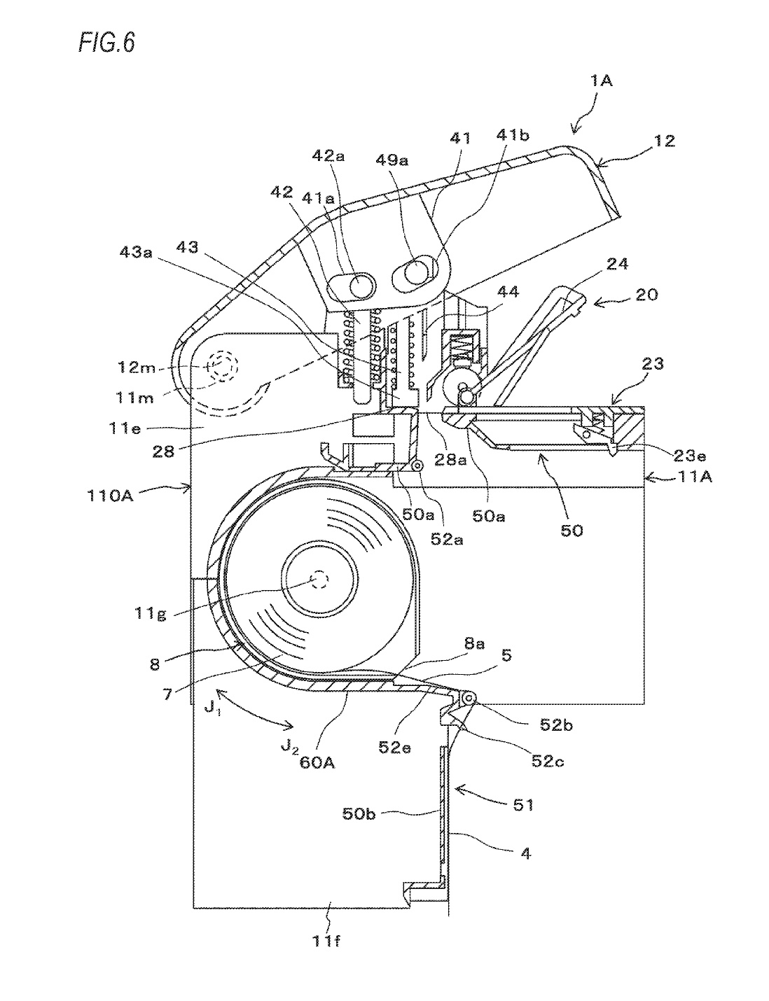

FIG. 6 illustrates an opened and closed state of the cassette storage unit. In the below, operations of attaching and detaching the cassette 8, the tape 5 and the release paper 4 in the binding device 1A are described.

As shown in FIG. 6, when the lower frame body 11f is opened by a rotation operation about the shaft 11g serving as a support point in an arrow J₁ direction, the front side of the cassette storage unit 60A is opened. Thereby, the cassette 8 can be attached and detached from the front side of the base unit 11A.

Also, when the lower frame body 11f is opened, the second guide configuring member 50b is opened downwards with respect to the first guide configuring member 50a, and the second roller 52b and the engaging claw 52c are retreated from the conveyance path, so that the conveyance path 51 is exposed. Thereby, it is possible to easily perform the operations of pulling out the tape 5 from the cassette 8 mounted to the cassette storage unit 60A, hooking the engaging hole 6 (FIG. 4) to the engaging claw 52c and mounting the tape 5 and the release paper 4 to the conveyance path 51.

As shown in FIG. 1, when the lower frame body 11f is closed by a rotation operation about the shaft 11g serving as a support point in an arrow J₂ direction, the cassette 8 is held in the cassette storage unit 60A. Also, when the lower frame body 11f is closed, the first guide configuring member 50a and the second guide configuring member 50b face each other and form the conveyance path 51 and the tape 5 and the release paper 4 are mounted to a predetermined conveyance path.

In this way, the cassette storage unit 60A is provided at the lower part of the base unit 11A and the lower frame body 11f is configured to be openable and closable, so that the cassette storage unit 60A and the conveyance path 51 can be opened and closed. Therefore, at the state where the lower frame body 11f is opened, the entire conveyance path of the tape 5 and the release paper 4, including parts to be pulled out from the cassette storage unit 60A, is exposed, as shown in FIG. 6. Thereby, it is possible to easily attach and detach the tape 5 and the release paper 4.

In the meantime, in the first embodiment, the roll body 7 is accommodated in the cassette 8. However, a configuration where the cassette storage unit 60A is formed in conformity to the roll body 7 and the roll body 7 can be directly accommodated in the cassette storage unit 60A is also possible.

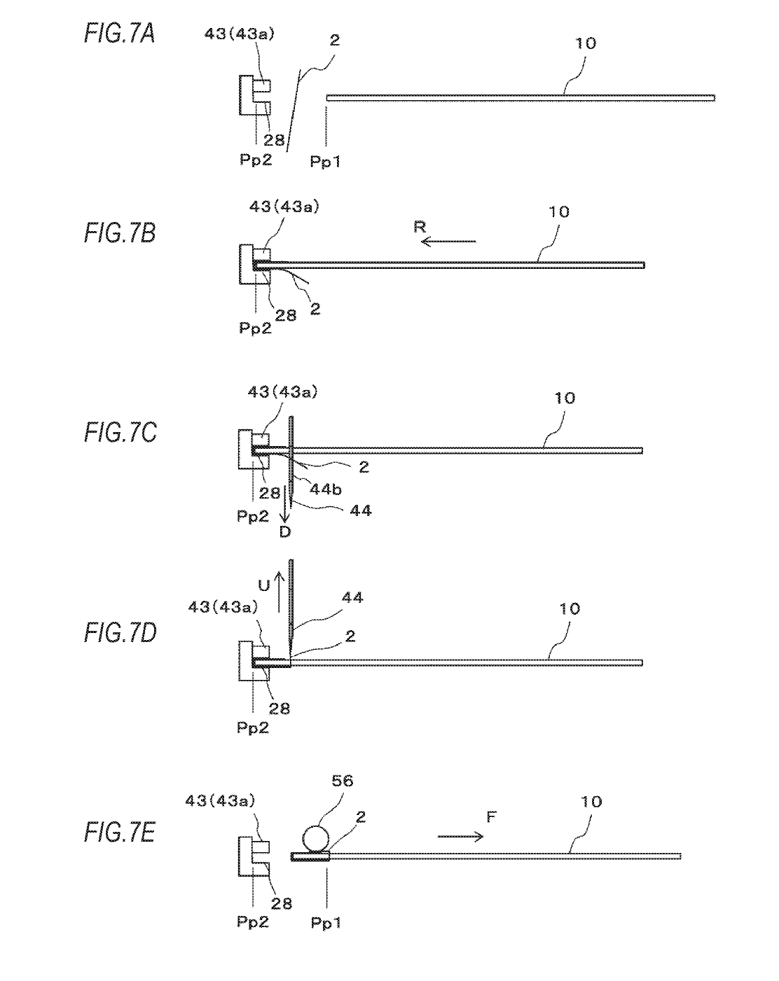

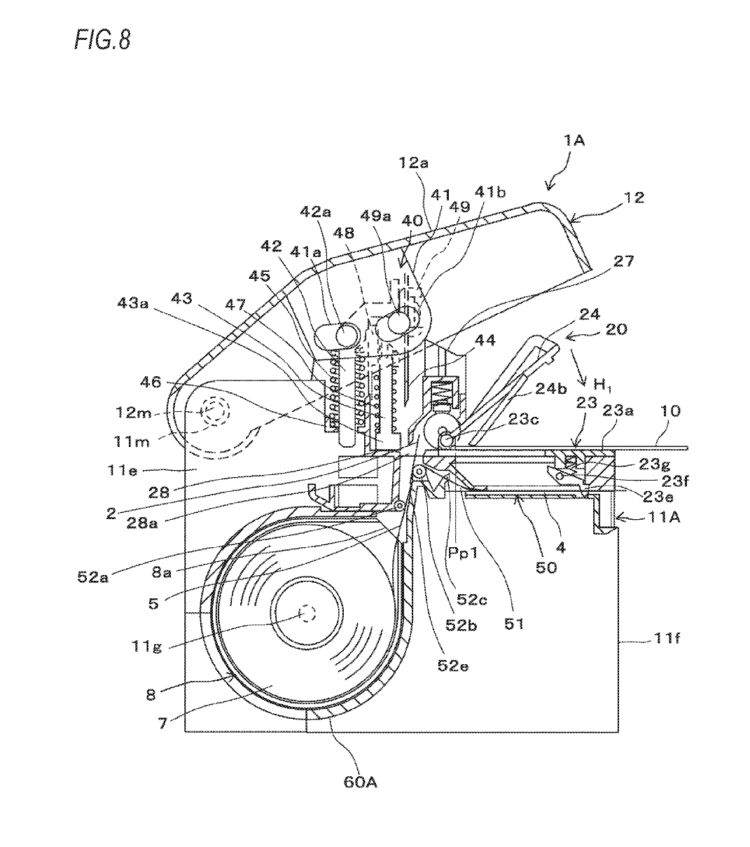

FIG. 7 illustrates an outline of an operation of binding the sheet bundle with the piece, and FIGS. 8 to 13 illustrate an example of an operation of the binding device of the first embodiment. In the below, an operation of binding the sheet bundle 10 with the piece 2 in the binding device 1A of the first embodiment is described.

At a standby state shown in FIGS. 7A and 8, the handle unit 12 is not operated and the cutting blade 44 is retreated to a standby position above the entrance groove 28. Also, the pushing member 24 is rotated in the arrow H₂ direction, so that the holding unit 20 is opened relative to the tray 23 and is located at the inserting/drawing position Pp1.

Also, about a half part of the piece 2 released from the release paper 4 protrudes to the piece standby part 28a, is held by the holding unit 20 and stands by on a moving path of the sheet bundle 10 moving from the inserting/drawing position Pp1 to the binding position Pp2, as shown in FIG. 7A.

In the binding device 1A at the standby state, when the sheet bundle 10 is put on the placement part 23a of the tray 23, the pushing member 24 and the elastic piece 24b are elastically deformed in accordance with a thickness of the sheet bundle 10 and is temporarily pressed to the placement part 23a by the elastic pieces 24b.

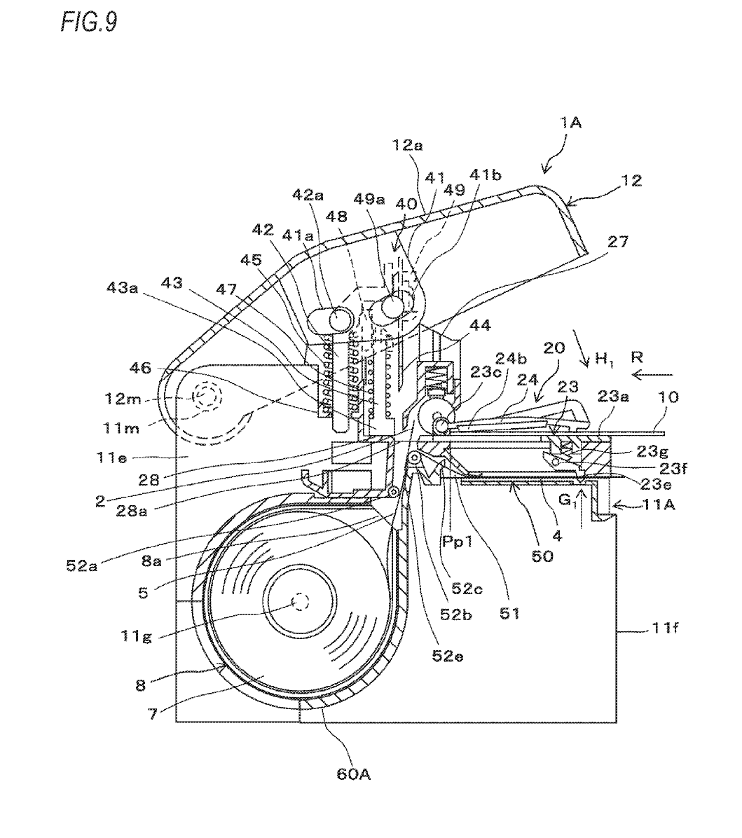

At a holding state of the sheet bundle 10 shown in FIG. 9, when the pushing member 24 is pushed in the arrow H₁ direction by an operator, the pushing member 24 is rotated about the rotary shaft 23c serving as a support point in the arrow H₁ direction and the pushing member 24 and the elastic pieces 24b are further elastically deformed, so that the sheet bundle 10 is held between the pushing member 24 and the tray 23 by the elastic pieces 24b.

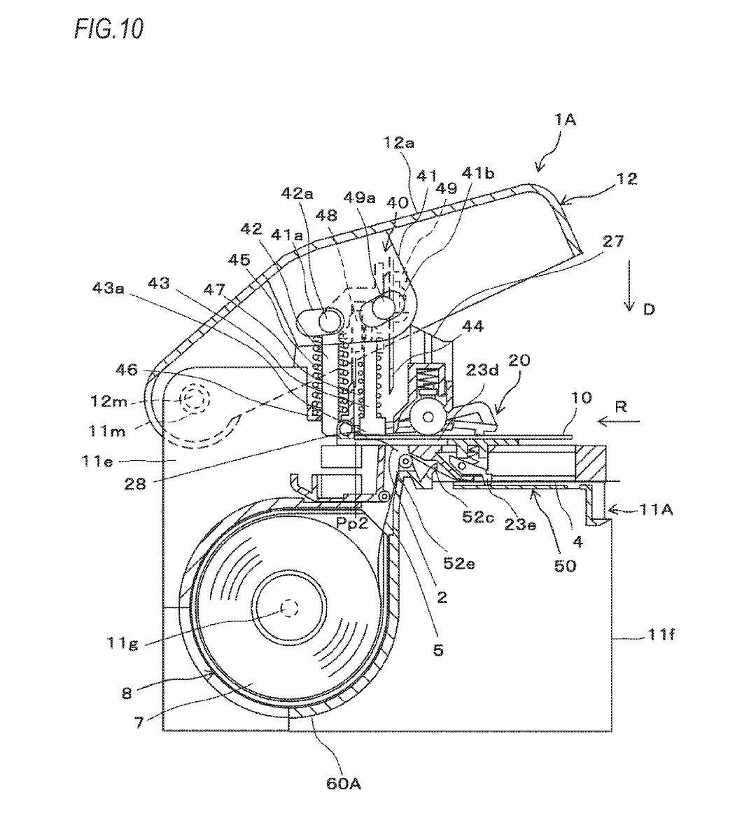

At a state of FIG. 10 where the piece 2 is to be preliminarily shaped, when the holding unit 20 holding the sheet bundle 10 is pushed in the arrow R direction by the operator, the holding unit 20 holding the sheet bundle 10 is moved from the inserting/drawing position Pp1 in the arrow R direction, so that the end portion 10a of the sheet bundle 10 is contacted to the piece 2 standing by at the piece standby part 28a. When the holding unit 20 holding the sheet bundle 10 is further pushed in the arrow R direction, the sheet bundle 10 and the piece 2 pushed to the sheet bundle 10 are interposed between the pressing part 43a of the pressing lever 43 and the entrance groove 28.

Then, when the holding unit 20 holding the sheet bundle 10 is moved to the binding position Pp2, the piece 2 is introduced into an unevenness shape formed by a combination of the pressing part 43a of the pressing lever 43, the entrance groove 28 and the end portion 10a of the sheet bundle 10, as shown in FIG. 7B. Thereby, the piece 2 is preliminarily shaped in conformity to the shape formed by the end portion 10a of the sheet bundle 10, the pressing part 43a of the pressing lever 43 and the entrance groove 28 and is released from the release paper 4.

During the operation in which the holding unit 20 holding the sheet bundle 10 is moved from the inserting/drawing position Pp1 to the binding position Pp2, the tape 5 and the release paper 4 are applied with a force in the reverse conveying direction, so that the engaging claw 52c is engaged with the engaging hole 6 of the release paper 4. Also, the holding claw 23e is rotated above the shaft 23f serving as a support point in the arrow G₁ direction, against the spring 23g, and is retreated from the conveyance path of the release paper 4. Thereby, the holding claw 23e is disengaged from the engaging hole 6 of the release paper 4, and the tape 5 and the release paper 4 are not reversely conveyed with the operation of moving the holding unit 20 from the inserting/drawing position Pp1 to the binding position Pp2.

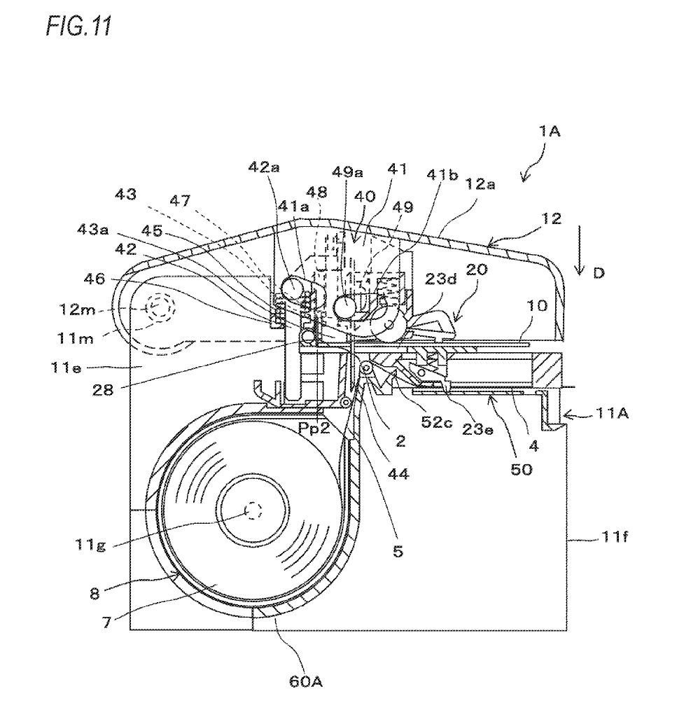

At a state of FIG. 11 where the sheet bundle 10 is to be punched with the cutting blade 44, when the operator grips the gripping part 12a of the handle unit 12 and pushes down the handle unit 12 in the arrow D direction, against the urging force of the coil spring 45, the convex portion 42a of the guide lever 42 is pressed by the first guide hole 41a of the driving member 41 with the rotation operation of the handle unit 12 about the shaft 12m serving as a support point in the arrow D direction, so that the guide lever 42 is moved in the arrow D direction.

When the guide lever 42 is moved in the arrow D direction, the moving member 48 is pressed by the guide lever 42 and the pressing lever 43 is pressed via the pressing spring 47, so that the pressing lever 43 is moved in the arrow D direction. Thereby, the sheet bundle 10 moved to the binding position Pp2 with being held with the holding unit 20 is pressed by the pressing part 43a of the pressing lever 43, and a part of the preliminarily shaped the piece 2 interposed between the pressing part 43a of the pressing lever 43 and the entrance groove 28 is bonded to a front surface and a back surface of the sheet bundle 10.

Also, when the handle unit 12 is pushed down in the arrow D direction, the convex portion 49a configured to drive the cutting blade 44 by the second guide hole 41b of the driving member 41 is pressed with the rotation operation of the handle unit 12 about the shaft 12m serving as a support point in the arrow D direction, so that the cutting blade 44 is moved in the arrow D direction.

Then, when the handle unit 12 is pushed down until it reaches a bottom dead point, the cutting blade 44 penetrates the sheet bundle 10 at the state where the sheet bundle 10 is pressed by the pressing lever 43, as shown in FIG. 7C. When the cutting blade 44 penetrates the sheet bundle 10, a free end of the back surface of the sheet bundle 10, which is a part of the piece 2 not bonded to the sheet bundle 10, is introduced into the insertion hole 44b of the cutting blade 44.

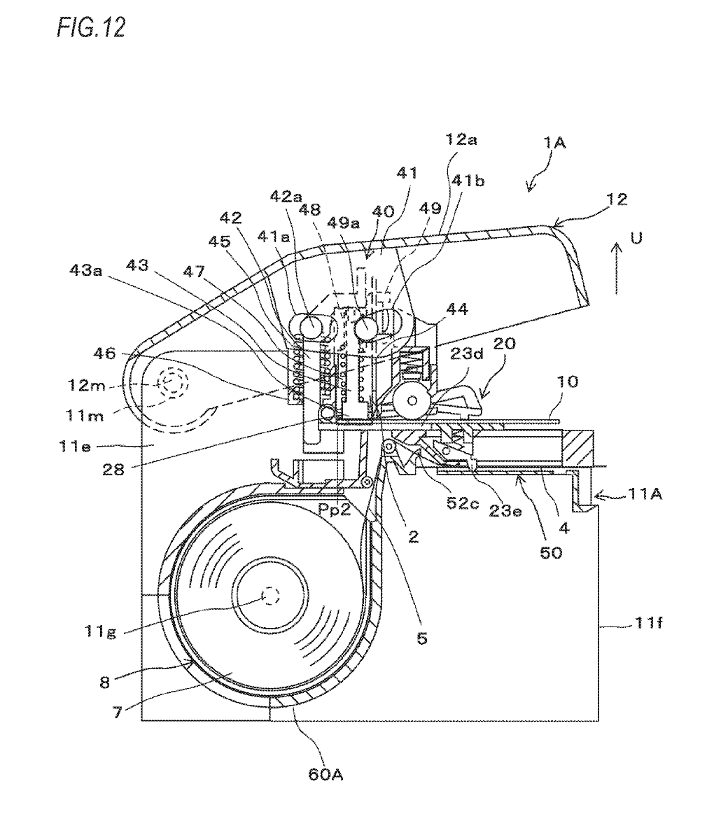

At a state of FIG. 12 where the piece 2 is to be inserted into the sheet bundle 10, when the force of pressing the handle unit 12 becomes weaker than the restoring force of the coil spring 45 as the force of gripping the gripping part 12a of the handle unit 12 is weakened, for example, the first guide hole 41a of the driving member 41 is pressed with the restoring force of the coil spring 45 via the convex portion 42a of the guide lever 42, so that the handle unit 12 is pushed up in the arrow U direction.

When the guide lever 42 is moved in the arrow U direction by the rotation operation of the handle unit 12 about the shaft 12m serving as a support point in the arrow U direction, the pressing lever 43 is pushed up via the pressing spring 47, so that the pressing lever 43 is moved in the arrow U direction and the sheet bundle 10 is released from the pressed state.

Also, the convex portion 49a configured to drive the cutting blade 44 by the second guide hole 41b of the driving member 41 is pushed up with the rotation operation of the handle unit 12 about the shaft 12m serving as a support point in the arrow U direction, so that the cutting blade 44 is moved in the arrow U direction. Then, as shown in FIG. 7D, as the cutting blade 44 returns, i.e., the cutting blade 44 having penetrated the sheet bundle 10 is pulled out, the free end of the piece 2 inserted in the insertion hole 44b is pulled out to the surface-side of the sheet bundle 10, in succession to the cutting blade 44.

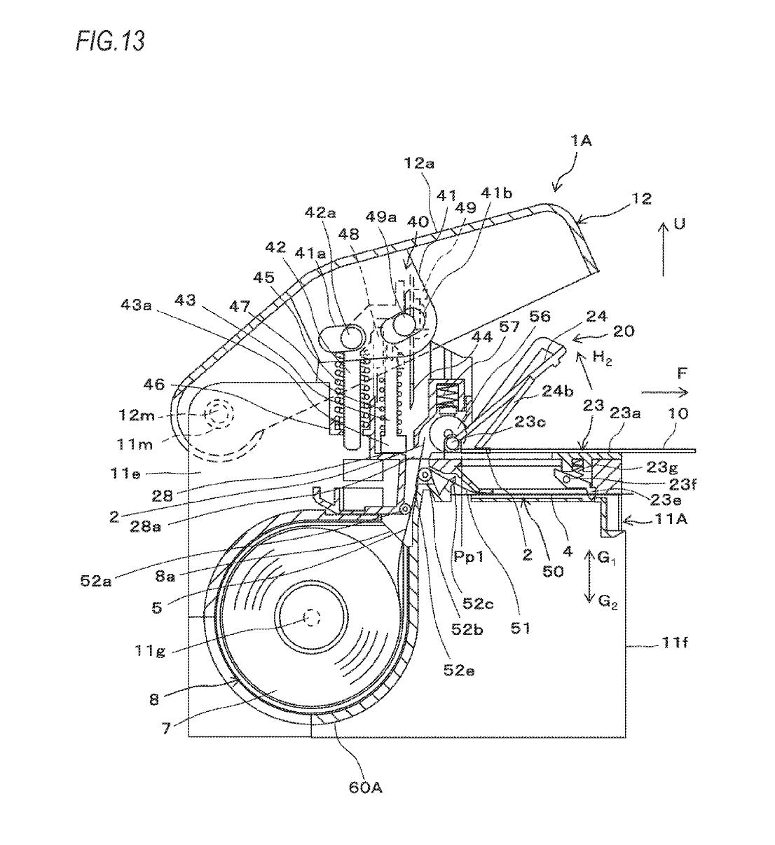

At a state of FIG. 13 where the piece 2 is to be finally shaped and the sheet bundle 10 is to be pulled out, after the handle unit 12 is pushed up to a top dead point and returns to the standby position, the holding unit 20 holding the sheet bundle 10 is moved in the arrow F direction. During the operation where the holding unit 20 is moved from the binding position Pp2 to the inserting/drawing position Pp1, the piece 2 inserted in the sheet bundle 10 is interposed between the sheet bundle 10 and the pressing roller 56, as shown in FIG. 7E. Then, the piece 2 is pressed to the sheet bundle 10 by the pressing roller 56, so that the piece 2 is bonded to the sheet bundle 10 and is finally shaped.

During the operation where the holding unit 20 is moved from the binding position Pp2 to the inserting/drawing position Pp1, the holding claw 23e is moved in the arrow F direction, so that the holding claw is rotated about the shaft 23f serving as a support point in the arrow G₂ direction by the force of the spring 23g and protrudes to the conveyance path of the release paper 4. Thereby, the holding claw 23e is engaged with the engaging hole 6 of the release paper 4, and the force of moving the release paper 4 in the arrow F direction is applied. When the force of moving the release paper 4 in the arrow F direction is applied, the engaging claw 52c is disengaged from the engaging hole 6 of the release paper 4 and the release paper 4 is introduced into the retreat part 52d.

Thereby, the tape 5 and the release paper 4 are pulled out by a length of one piece 2 by the operation of moving the holding unit 20 from the binding position Pp2 to the inserting/drawing position Pp1. When the holding unit 20 is stopped and the force of moving the release paper 4 is not applied any more, the engaging claw 52c is engaged with the engaging hole 6 of the release paper 4. When the tape 5 and the release paper 4 are pulled out by a length of one piece 2, about a half part of a next piece 2, which is released from the release paper 4, protrudes to the piece standby part 28a.

After the holding unit 20 is moved to the inserting/drawing position Pp1, when the pushing member 24 is rotated about the rotary shaft 23c serving as a support point in the arrow H₂ direction and the pushing member 24 is thus opened, so that the sheet bundle 10 can be pulled out from the tray 23.

The binding device 1A has the configuration where the handle unit 12 is displaced by the rotation operation about the shaft 12m serving as a support point. The cassette storage unit 60A is provided at the part of the device main body 110A, which faces the gripping part 12a of the handle unit 12 via the sheet bundle 10, which is to be placed by the holding unit 20m, being interposed therebetween, in the first embodiment, the part at the rear of the gripping part 12a of the handle unit 12, i.e., the part of the side that faces the cutting blade 44 via the sheet bundle 10 being interposed therebetween. Therefore, any problem is not caused when gripping the gripping part 12a of the handle unit 12.

Also, the size of the device main body 110A in the front and rear direction can be made small, and the external shape of the cassette 8 to be accommodated in the cassette storage unit 60A is configured so that the cassette does not protrude rearwards beyond the rear end of the handle unit 12, in the first embodiment. Therefore, even when the device is used on a desk, it is possible to reduce a provision area thereof.

### Configuration Example of Binding Device of Second Embodiment

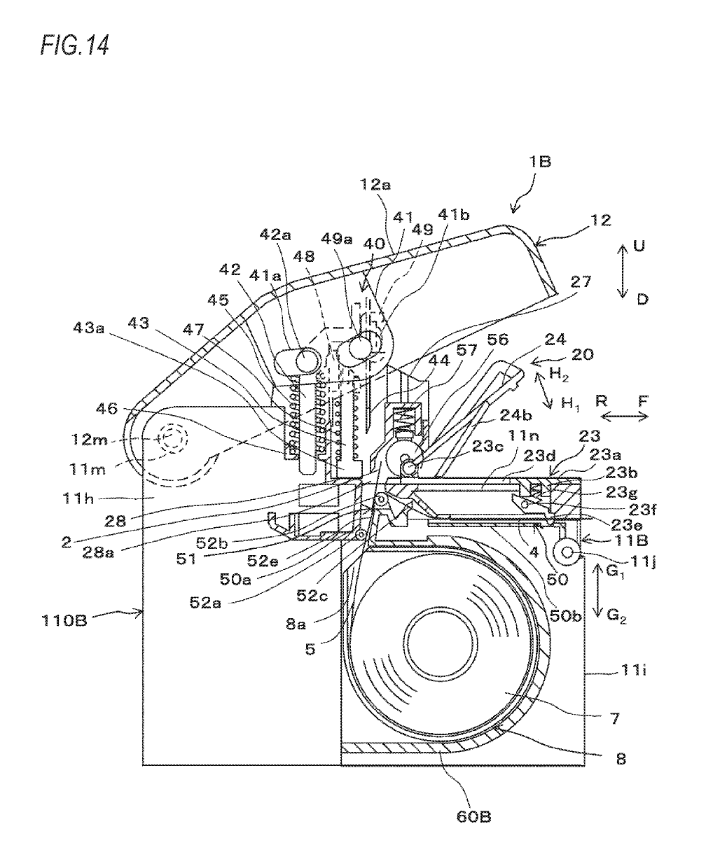

FIG. 14 is a configuration view depicting an example of a binding device in accordance with a second embodiment. A binding device 1B of the second embodiment is configured to accommodate the cassette 8 at a front and lower part. In the meantime, the equivalent configurations to the binding device 1A of the first embodiment are denoted with the same reference numerals and the detailed descriptions thereof are omitted.

The binding device 1B has a cassette storage unit 60B configured to detachably mount the cassette 8 thereto and provided at a lower part of a device main body 110B having a base unit 11B and the handle unit 12, in the second embodiment, at a front and lower part of the base unit 11B, which is an opposite side to the shaft 12m about which the handle unit 12 is to rotate. The base unit 11B has a main frame body 11h and a lower frame body 11i. The base unit 11B has the shaft support part 11m provided at a rear and upper part of the main frame body 11h. Also, the base unit 11B is attached so that the lower frame body 11i can rotate about a shaft 11j provided in front of the main frame body 11h and serving as a support point. The base unit 11B is configured so that the lower frame body 11i is to be opened forward and the lower part of the base unit 11B can be opened and closed by a rotation operation of the lower frame body 11i in an arrow K₁ direction and an arrow K₂ direction. Also in the binding device 1B, the handle unit 12 is provided with the gripping part 12a for gripping and operating the binding device 1B, and when operating the binding device 1B, it is possible to operate the same with gripping the gripping part 12a.

The conveyor unit 50 has a configuration where the main frame body 11h of the base unit 11B is provided with the first guide configuring member 50a and the first guide configuring member 50a is provided with the first roller 52a. Also, the conveyor unit 50 has a configuration where the lower frame body 11i of the base unit 11B is provided with the second guide configuring member 50b and the second guide configuring member 50b is provided with the second roller 52b and the engaging claw 52c.

The cassette storage unit 60B is an example of the storage unit, and is provided at a part of the device main body 110B, which faces the shaft 12m of the rotation operation of the handle unit 12 via the cutting blade 44 being interposed therebetween, in the second embodiment, at a front and lower part of the base unit 11B. The cassette storage unit 60B is configured so that the tape 5 provided at the lower frame body 11i and pulled out from the drawing port 8a of the cassette 8 is to be guided to the conveyance path 51 from the lower part of the conveyor unit 50 and the external shape of the cassette 8 to be accommodated therein does not protrude forward beyond a front end of the main frame body 11h, in the second embodiment.

Also in the cassette storage unit 60B, the cassette 8 is accommodated so that the drawing port 8a is positioned just below the conveyance path reaching the release part 52e, in the second embodiment, so that the drawing port 8a faces upwards, and a part at which the tape 5 is to be pulled out from the drawing port 8a is provided below the conveyance path 51, like the binding device 1A of the first embodiment.

The cassette storage unit 60B is provided at a part of the device main body 110B, in front of the gripping part 12a of the handle unit 12. Also, the cassette storage unit 60B is provided at a part that faces the cutting blade 44 via the sheet bundle 10, which is to be placed by the holding unit 20, being interposed therebetween. Also, the cassette storage unit 60B is provided at a part of a side at which the drawing port 8a of the cassette 8 faces the cutting blade 44 via the conveyor unit 50 being interposed therebetween. Also, the cassette storage unit 60B is provided at a part of a side that faces the gripping part 12a of the handle unit 12 via the sheet bundle 10, which is to be placed by the holding unit 20, being interposed therebetween.

The cassette storage unit 60B is provided at the lower frame body 11i, so that it can be opened and closed by the rotation operation of the lower frame body 11i about the shaft 11j serving as a support point.

### Operation Example of Binding Device of Second Embodiment

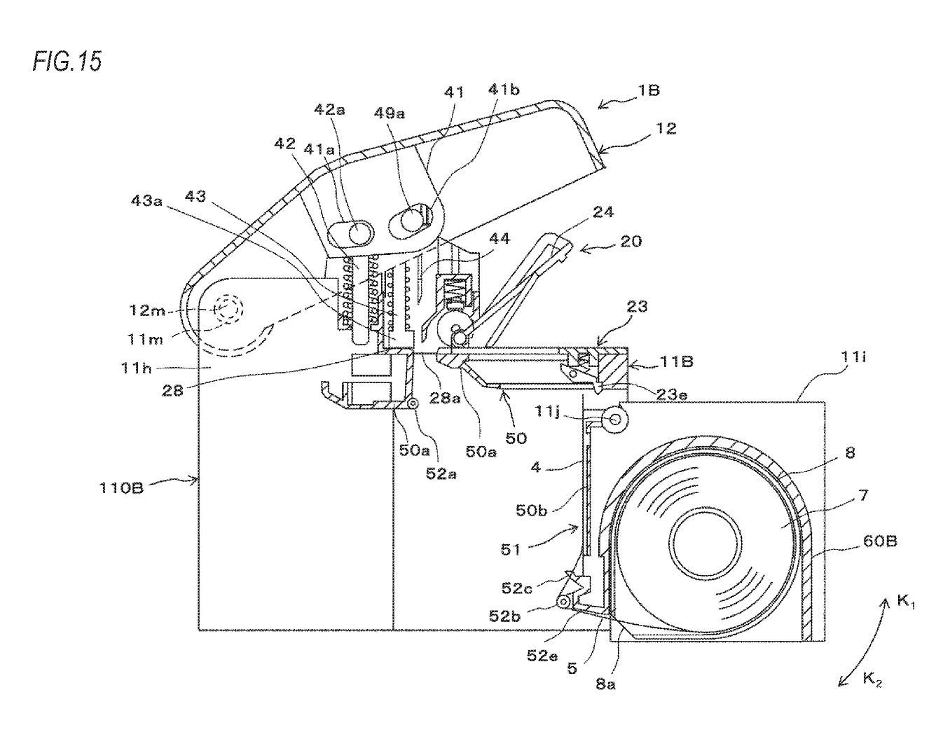

FIG. 15 illustrates an opened and closed state of the cassette storage unit. In the below, operations of attaching and detaching the cassette 8, the tape 5 and the release paper 4 in the binding device 1B are described.

As shown in FIG. 15, when the lower frame body 11i is opened by a rotation operation about the shaft 11j serving as a support point in the arrow K₁ direction, the cassette storage unit 60B is opened. Thereby, the cassette 8 can be attached and detached from the lower side of the base unit 11B.

Also, when the lower frame body 11i is opened, the second guide configuring member 50b is opened downwards with respect to the first guide configuring member 50a, and the second roller 52b and the engaging claw 52c are retreated from the conveyance path, so that the conveyance path 51 is exposed. Thereby, it is possible to easily perform the operations of pulling out the tape 5 from the cassette 8 mounted to the cassette storage unit 60B, hooking the engaging hole 6 (FIG. 4) to the engaging claw 52c and mounting the tape 5 and the release paper 4 to the conveyance path 51.

As shown in FIG. 14, when the lower frame body 11i is closed by a rotation operation about the shaft 11j serving as a support point in the arrow K₂ direction, the cassette 8 is mounted to a predetermined position, the first guide configuring member 50a and the second guide configuring member 50b face each other and form the conveyance path 51, and the tape 5 and the release paper 4 are mounted to a predetermined conveyance path.

In this way, the cassette storage unit 60B is provided at the lower part of the base unit 11B and the lower frame body 11i is configured to be openable and closable, so that the cassette storage unit 60B and the conveyance path 51 can be opened and closed. Therefore, at the state where the lower frame body 11i is opened, the entire conveyance path of the tape 5 and the release paper 4, including parts to be pulled out from the cassette storage unit 60B, is exposed, as shown in FIG. 15. Thereby, it is possible to easily attach and detach the tape 5 and the release paper 4.

In the meantime, also in the second embodiment, the roll body 7 is accommodated in the cassette 8. However, a configuration where the cassette storage unit 60B is formed in conformity to the roll body 7 and the roll body 7 can be directly accommodated in the cassette storage unit 60B is also possible.

The binding device 1B also has the configuration where the handle unit 12 is displaced by the rotation operation about the shaft 12m serving as a support point. The cassette storage unit 60B is provided at the part of the device main body 110B, which faces the gripping part 12a of the handle unit 12 via the sheet bundle 10, which is to be placed by the holding unit 20m, being interposed therebetween, in the second embodiment, the part in front of the gripping part 12a of the handle unit 12, i.e., the part of the side that faces the cutting blade 44 via the sheet bundle 10 being interposed therebetween. Therefore, any problem is not caused when gripping the gripping part 12a of the handle unit 12.

Also, the size of the device main body 110B in the front and rear direction can be made small, and the external shape of the cassette 8 to be accommodated in the cassette storage unit 60B is configured so that the cassette does not protrude rearwards beyond the rear end of the handle unit 12, in the second embodiment. Therefore, even when the device is used on a desk, it is possible to reduce a provision area thereof.

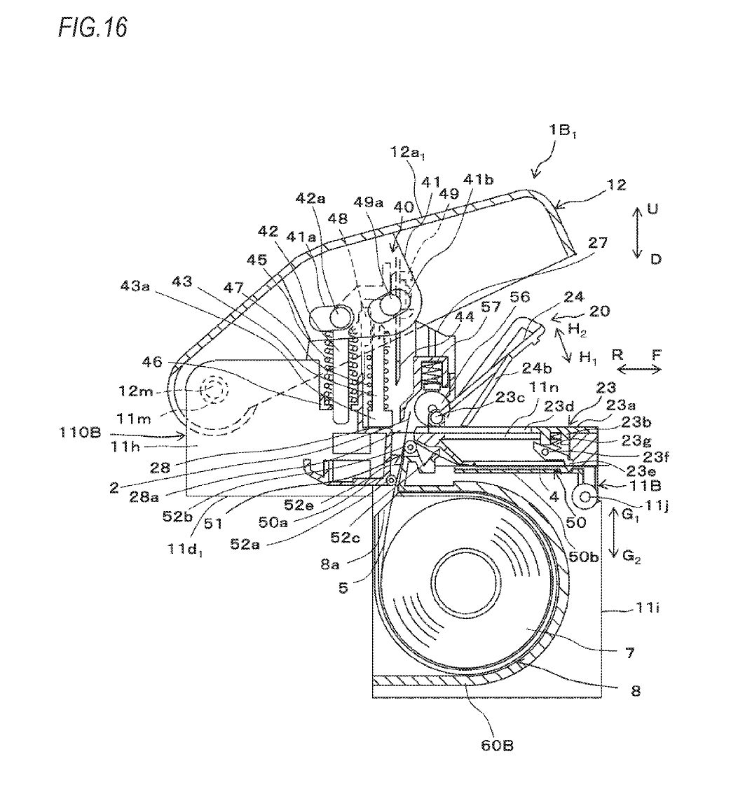

FIG. 16 is a configuration view depicting a modified embodiment of the binding device in accordance with the second embodiment. In the meantime, the equivalent configurations to the binding device 1B of the second embodiment are denoted with the same reference numerals and the detailed descriptions thereof are omitted.

In a binding device 1B₁ of the modified embodiment, the handle unit 12 is provided with a first gripping part 12a₁ for gripping and operating the binding device 1B₁. Also, a second gripping part 11 d₁ for gripping and operating the binding device 1B₁ is provided by cutting a rear and lower part of the main frame body 11h, which is a non-formation position of the cassette storage unit 60B. When operating the binding device 1B₁, it is possible to operate the same with gripping the first gripping part 12a₁ and the second gripping part 11d₁.

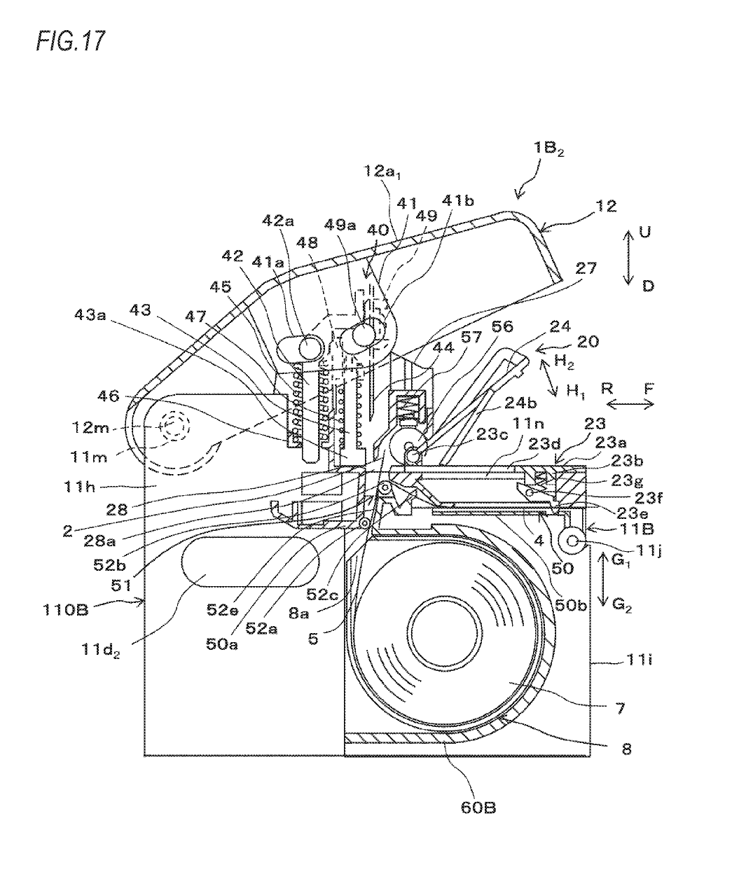

FIG. 17 is a configuration view depicting another modified embodiment of the binding device in accordance with the second embodiment. In the meantime, the equivalent configurations to the binding device 1B of the second embodiment are denoted with the same reference numerals and the detailed descriptions thereof are omitted.

In a binding device 1B₂ of another modified embodiment, the handle unit 12 is provided with a first gripping part 12a₁ for gripping and operating the binding device 1B₂. Also, a second gripping part 11d₂ for gripping and operating the binding device 1B₂ is provided by forming a long opening in which a finger is to enter at a rear and lower part of the main frame body 11h, which is a non-formation position of the cassette storage unit 60B. When operating the binding device 1B₂, it is possible to operate the same with gripping the first gripping part 12a₁ and the second gripping part 11d₂.

In any of the modified embodiments, the cassette storage unit 60B is provided at the part of the device main body 110B in front of the first gripping part 12a₁ of the handle unit 12. Therefore, a degree of freedom of the shape of the base unit 11B increases, so that it is possible to form a shape more appropriate to the gripping.

### Configuration Example of Binding Device of Third Embodiment

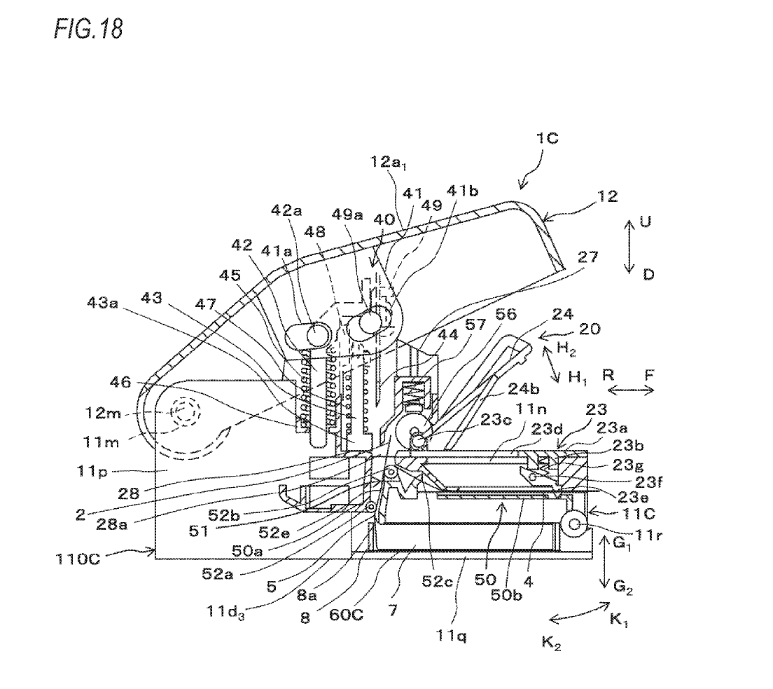

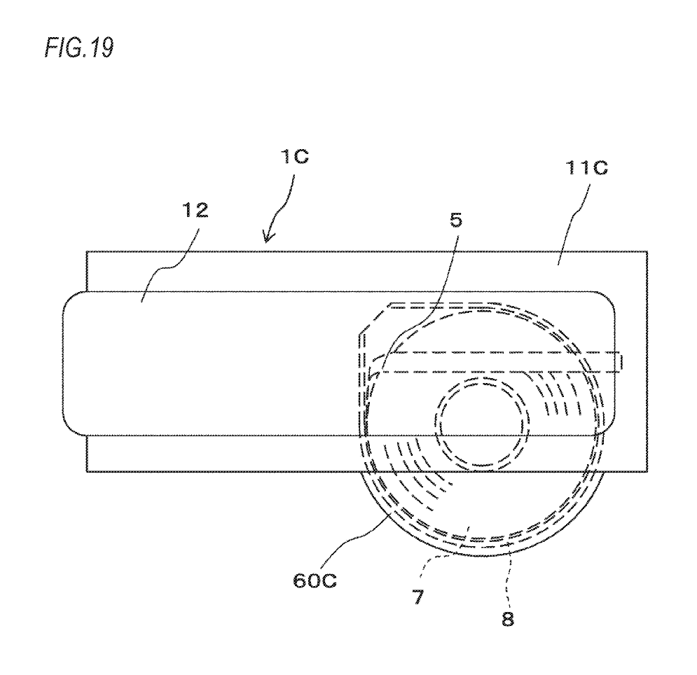

FIGS. 18 and 19 are configuration views depicting an example of a binding device in accordance with a third embodiment. Herein, FIG. 18 is a side view depicting an internal configuration of the binding device 1C, and FIG. 19 is a plan view of the binding device 1C. A binding device 1C of the third embodiment is configured to accommodate the cassette 8 in a front and lower part with keeping the same in the horizontal direction. In the meantime, the equivalent configurations to the binding device 1A of the first embodiment are denoted with the same reference numerals and the detailed descriptions thereof are omitted.

The binding device 1C has a cassette storage unit 60C configured to detachably mount the cassette 8 thereto and provided at a lower part of a device main body 110C having a base unit 11C and the handle unit 12, in the third embodiment, at a front and lower part of the base unit 11C, which is an opposite side to the shaft 12m about which the handle unit 12 is to rotate. The base unit 11C has a main frame body 11p and a lower frame body 11q. The base unit 11C has the shaft support part 11m provided at a rear and upper part of the main frame body 11p. Also, the base unit 11C is attached so that the lower frame body 11q can rotate about a shaft 11r provided in front of the main frame body 11p and serving as a support point. The base unit 11C is configured so that the lower frame body 11q is to be opened forward and the lower part of the base unit 11C can be opened and closed by a rotation operation of the lower frame body 11q in the arrow K₁ direction and the arrow K₂ direction. In the binding device 1C, the handle unit 12 is provided with the first gripping part 12a₁ for gripping and operating the binding device 1C. Also, the binding device 1C is provided with a second gripping part 12d₃ for gripping and operating the binding device 1C. When operating the binding device 1C, it is possible to operate the same with gripping the first gripping part 12a₁ and the second gripping part 12d₃.

The conveyor unit 50 has a configuration where the main frame body 11p of the base unit 11C is provided with the first guide configuring member 50a and the first guide configuring member 50a is provided with the first roller 52a. Also, the conveyor unit 50 has a configuration where the lower frame body 11q of the base unit 11C is provided with the second guide configuring member 50b and the second guide configuring member 50b is provided with the second roller 52b and the engaging claw 52c.

Thereby, when the lower frame body 11q is opened by a rotation operation about the shaft 11r serving as a support point in the arrow K₁ direction, the cassette storage unit 60B is opened and the cassette 8 can be attached and detached. Also, the second guide configuring member 50b is opened downwards with respect to the first guide configuring member 50a and the conveyance path 51 is exposed, so that the tape 5 and the release paper 4 can be attached and detached.

Also, when the lower frame body 11q is closed by a rotation operation about the shaft 11r serving as a support point in the arrow K₂ direction, the cassette 8 is mounted to a predetermined position, the first guide configuring member 50a and the second guide configuring member 50b face each other and form the conveyance path 51 and the tape 5 and the release paper 4 are mounted to a predetermined conveyance path.

In the cassette storage unit 60C, the cassette 8 is accommodated in the horizontal direction so that the circumferential direction of the roll body 7 becomes the horizontal direction, and the tape 5 pulled out from the drawing port 8a of the cassette 8 is guided to the conveyance path 51 from the lower part of the conveyor unit 50. In the third embodiment, an external shape of the cassette 8 is configured so that it does not protrude forward beyond the front end of the main frame body 11h. That is, the cassette storage unit 60C is provided at a part of the device main body 110B, which faces the shaft 12m of the rotation operation of the handle unit 12 via the cutting blade 44 being interposed therebetween.

In the cassette storage unit 60C, a part at which the tape 5 is to be pulled out from the drawing port 8a is provided below the conveyance path 51, and the conveyance path is bent so that the tape 5, which is to be pulled out from the drawing port 8a of the cassette 8 in the horizontal direction, is to be conveyed in the vertical direction at the release part 52e, as shown in FIG. 19.

The cassette storage unit 60C is provided at a part of the device main body 110C, in front of the first gripping part 12a₁ of the handle unit 12 or the second gripping part 11d₃ of the base unit 11C. Also, the cassette storage unit 60C is provided at a part of a side that faces the cutting blade 44 via the sheet bundle 10, which is to be placed by the holding unit 20, being interposed therebetween. Also, the cassette storage unit 60C is provided at a part of a side at which the drawing port 8a of the cassette 8 faces the cutting blade 44 via the conveyor unit 50 being interposed therebetween. Also, the cassette storage unit 60C is provided at a part of a side that faces the first gripping part 12a₁ of the handle unit 12 via the sheet bundle 10, which is to be placed by the holding unit 20, being interposed therebetween.

In the binding device 1C, the cassette 8 is attached in the horizontal direction, so that it is possible to suppress a size in a height direction, too. Thereby, a degree of freedom of the shape of the base unit 11C increases, so that it is possible to form a shape more appropriate to the gripping. Also, it is possible to make the size of the device main body 110C in the front and rear direction small, and even when the device is used on a desk, it is possible to reduce a provision area thereof.

Meanwhile, in the binding device 1A, the binding device 1B and the binding device 1C, the piece 2 is preliminarily shaped by the relative movement between the sheet bundle 10 and the piece 2 resulting from the movement of the sheet bundle 10, and the operation of the holding unit 20 moving the sheet bundle 10 may be performed in conjunction with the operation of the handle unit 12. Also, the piece 2 may preliminarily shaped by the relative movement between the sheet bundle 10 and the piece 2 resulting from movement of the piece 2, without moving the sheet bundle 10.

Also, in the binding device 1A, the binding device 1B and the binding device 1C, the operation member configured to move the cutting blade 44 and the pressing lever 43 by the linear movement may be provided just above the cutting blade 44 and the pressing lever 43.

### Configuration Example of Binding Device of Fourth Embodiment

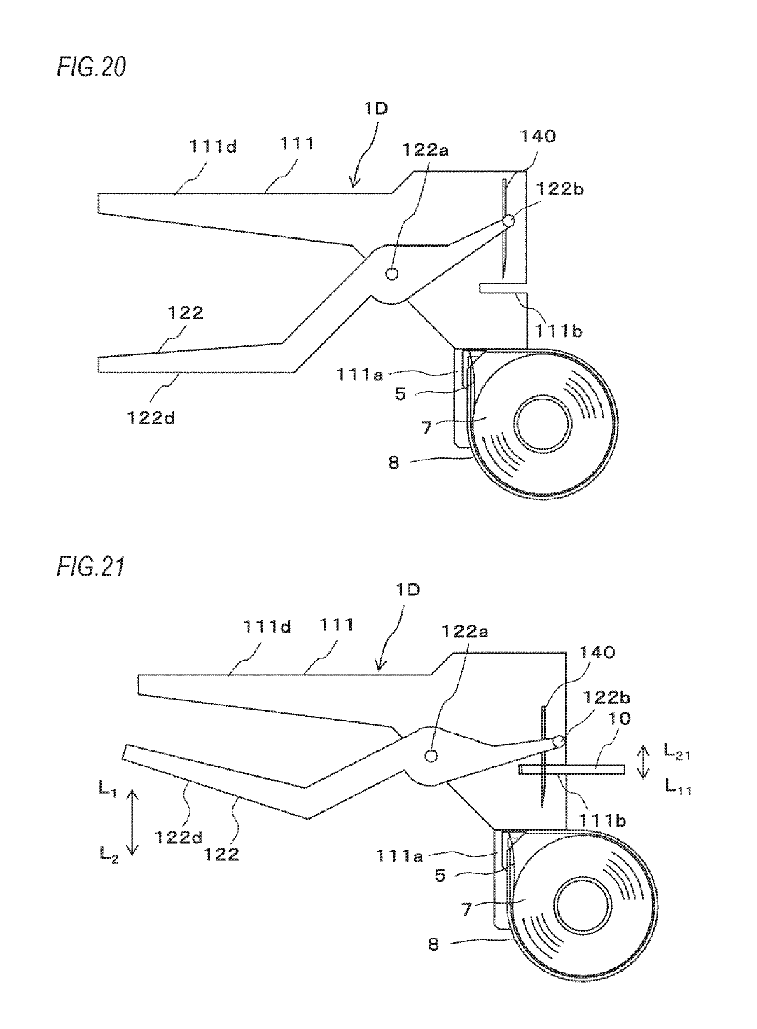

FIGS. 20 and 21 are configuration views depicting an example of a binding device in accordance with a fourth embodiment. A binding device 1D has a base unit 111 and a handle unit 122 provided to be rotatable relative to the base unit 111.

The base unit 111 has a cassette storage unit 111a, to which the cassette 8 having the roll body 7 of the tape 5 accommodated therein is to be detachably mounted, at a front and lower part. Also, the base unit 111 has an entrance groove 111b in which the sheet bundle 10 is to be inserted. Also, although not shown, the base unit 111 has the conveyor unit configured to convey the tape 5 and the release paper 4 pulled out from the cassette 8, the configuration for preliminarily shaping the piece, and the like, which have been described in the respective embodiments.

The handle unit 122 is an example of the operation member and is attached to the base unit 111 so as to be rotatable about a shaft 122a serving as a support point. The handle unit 122 has a coupling part 122b, to which a cutting blade 140 is to be coupled, at one end portion-side, and the other end portion-side becomes a free end. In the binding device 1D, the handle unit 122 is provided with a first gripping part 122d for gripping and operating the binding device 1D. Also, the base unit 111 is provided with a second gripping part 111d for gripping and operating the binding device 1D, and when operating the binding device 1D, it is possible to operate the same with gripping the first gripping part 122d and the second gripping part 111d.

The cassette storage unit 111a is provided at a part in front of the first gripping part 122d of the handle unit 122 or the second gripping part 111d of the base unit 111. Also, the cassette storage unit 111a is provided at a part of a side that faces the cutting blade 44 via the sheet bundle 10, which is to be placed on the entrance groove 111b, being interposed therebetween. Also, the cassette storage unit 111a is provided at a part of a side that faces the first gripping part 122d of the handle unit 122, via the sheet bundle 10, which is to be placed on the entrance groove 111b, being interposed therebetween.

In the binding device 1D, when the first gripping part 122d and the second gripping part 111d are gripped, the handle unit 122 rotates about the shaft 122a serving as a support point, and the rotation operation of the handle unit 122 is transmitted to the cutting blade 140.

When the handle unit 122 is operated in an arrow L₁ direction, it rotates about the shaft 122a serving as a support point, so that the cutting blade 140 is moved in an arrow L₁₁ direction and penetrates the sheet bundle 10 inserted in the entrance groove 111b. Also, although not shown, the preliminarily shaped piece is held by the cutting blade 140.

When the handle unit 122 is operated in an arrow L₂ direction, it rotates about the shaft 122a serving as a support point, so that the cutting blade 140 is moved in an arrow L₂₁ direction and the cutting blade 140 having penetrated the sheet bundle 10 is pulled out. By this operation, the piece is pulled out to the surface-side of the sheet bundle 10, in succession to the cutting blade 140.

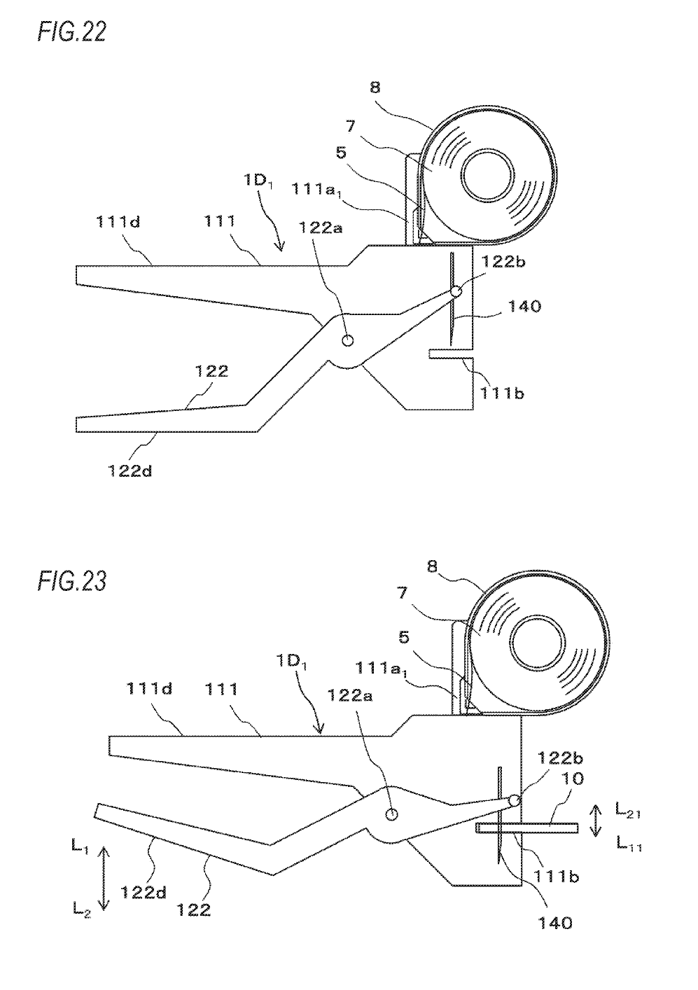

FIGS. 22 and 23 are configuration views depicting a modified embodiment of the binding device in accordance with the fourth embodiment. In a binding device 1D₁ of the modified embodiment, a cassette storage unit 111a₁ is provided at a part in front of the first gripping part 122d of the handle unit 122 or the second gripping part 111d of the base unit 111. Also, the cassette storage unit 111a₁ is provided at a part of a side that faces the cutting blade 44. Also, the cassette storage unit 111a₁ is provided at a part of a side that faces the first gripping part 122d of the handle unit 122 via the sheet bundle 10, which is to be placed on the entrance groove 111b, being interposed therebetween.

In the binding device 1D, the cassette 8 is attached to the front and lower part of the device, and in the binding device 1D₁, the cassette 8 is attached to a front and upper part of the device, so that there is no shape protruding rearwards from the handle unit 122-side. Thereby, the degree of freedom of shapes of the handle unit 122 and the base unit 111 increases. Therefore, for example, it is possible to make a shape by which it is possible to grip the device with one hand.

### Configuration Example of Binding Device of Fifth Embodiment

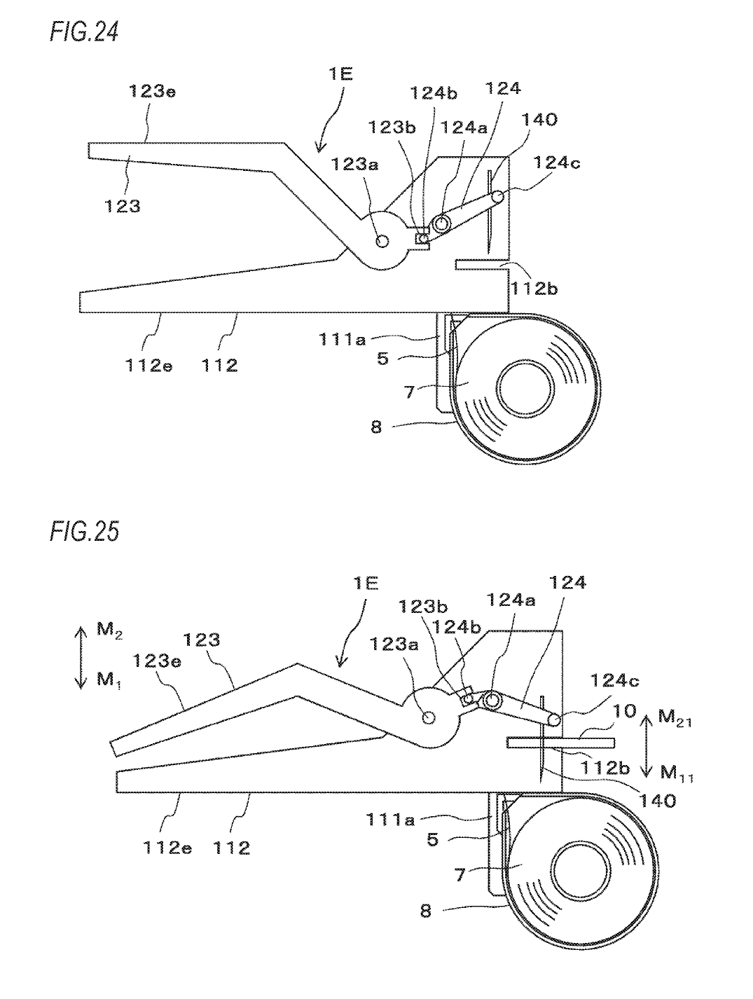

FIGS. 24 and 25 are configuration views depicting an example of a binding device in accordance with a fifth embodiment. A binding device 1E has a base unit 112, a handle unit 123 provided to be rotatable relative to the base unit 112 and a link 124 configured to transmit an operation of the handle unit 123 to the cutting blade 140.

The base unit 112 has a cassette storage unit 112a, to which the cassette 8 having the roll body 7 of the tape 5 accommodated therein is to be detachably mounted, at a front and lower part. Also, the base unit 112 has an entrance groove 112b in which the sheet bundle 10 is to be inserted. Also, although not shown, the base unit 112 has the conveyor unit configured to convey the tape 5 and the release paper 4 pulled out from the cassette 8, the configuration for preliminarily shaping the piece, and the like, which have been described in the respective embodiments.

The handle unit 123 is an example of the operation member and is attached to the base unit 112 so as to be rotatable about a shaft 123a serving as a support point. The handle unit 123 has a coupling part 123b, to which the link 124 is to be coupled, at one end portion-side, and the other end portion-side becomes a free end. In the binding device 1E, the handle unit 123 is provided with a first gripping part 123e for gripping and operating the binding device 1E. Also, the base unit 112 is provided with a second gripping part 112e for gripping and operating the binding device 1E, and when operating the binding device 1E, it is possible to operate the same with gripping the first gripping part 123e and the second gripping part 112e.

The cassette storage unit 112a is provided at a part in front of the first gripping part 123e of the handle unit 123 or the second gripping part 112e of the base unit 112. Also, the cassette storage unit 112a is provided at a part of a side that faces the cutting blade 44 via the sheet bundle 10, which is to be placed on the entrance groove 112b, being interposed therebetween. Also, the cassette storage unit 112a is provided at a part of a side that faces the first gripping part 123e of the handle unit 123 via the sheet bundle 10, which is to be placed on the entrance groove 112b, being interposed therebetween.

The link 124 is attached to the base unit 112 so as to be rotatable about a shaft 124a serving as a support point. The link 124 has a coupling shaft 124b, which is to be coupled with the coupling part 123b of the handle unit 123, at one end portion and a coupling part 124c, to which the cutting blade 140 is to be coupled, at the other end portion.

In the binding device 1E, when the first gripping part 123e and the second gripping part 112e are gripped, the handle unit 123 rotates the shaft 123a serving as a support point, the link 124 rotates about the shaft 124a serving as a support point, and the rotation operations of the handle unit 123 and the link 124 are transmitted to the cutting blade 140.

When the handle unit 123 is operated in an arrow M₁ direction, the handle unit 123 rotates about the shaft 123a serving as a support point and the link 124 rotates about the shaft 124a serving as a support point, so that the cutting blade 140 is moved in an arrow M₁₁ direction and penetrates the sheet bundle 10 inserted in the entrance groove 112b. Also, although not shown, the preliminarily shaped piece is held by the cutting blade 140.

When the handle unit 123 is operated in an arrow M₂ direction, the handle unit 123 rotates about the shaft 123a serving as a support point and the link 124 rotates about the shaft 124a serving as a support point, so that the cutting blade 140 is moved in an arrow M₂₁ direction and the cutting blade 140 having penetrated the sheet bundle 10 is pulled out. By this operation, the piece is pulled out to the surface-side of the sheet bundle 10, in succession to the cutting blade 140.

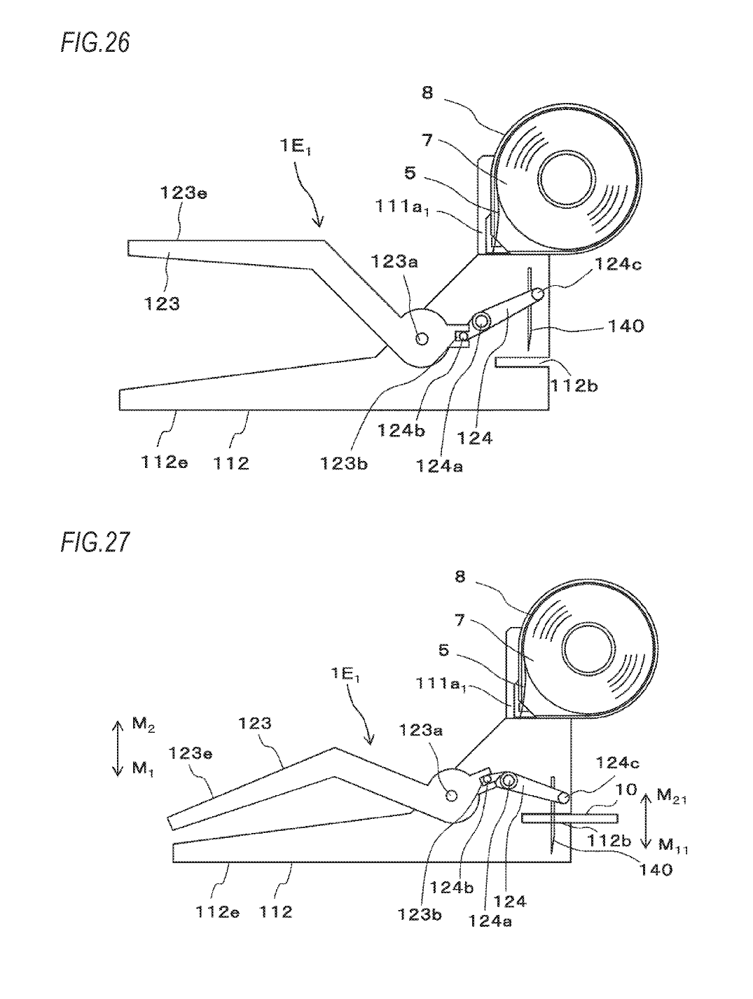

FIGS. 26 and 27 are configuration views depicting a modified embodiment of the binding device in accordance with the fifth embodiment. In a binding device 1E₁ of the modified embodiment, a cassette storage unit 111a₁ is provided at a part in front of the first gripping part 123e of the handle unit 123 or the second gripping part 112e of the base unit 112. Also, the cassette storage unit 111a₁ is provided at a part of a side that faces the cutting blade 44. Also, the cassette storage unit 111a₁ is provided at a part of a side that faces the first gripping part 123e of the handle unit 123 via the sheet bundle 10, which is to be placed on the entrance groove 111b, being interposed therebetween.

In the binding device 1E, the cassette 8 is attached to the front and lower part of the device, and in the binding device 1E₁, the cassette 8 is attached to a front and upper part of the device, so that there is no shape protruding rearwards from the handle unit 123-side. Thereby, a degree of freedom of shapes of the handle unit 123 and the base unit 112 increases. Therefore, for example, it is possible to make a shape by which it is possible to grip the device with one hand. Also, the operation of the handle unit 123 is transmitted to the cutting blade 140 by the link 124. Thereby, a degree of freedom of a setting of an operation ratio of the cutting blade 140 to the operation of the handle unit 123 is improved, and the degree of freedom of the shape of the handle unit 123 is further improved.

### Configuration Example of Binding Device of Sixth Embodiment

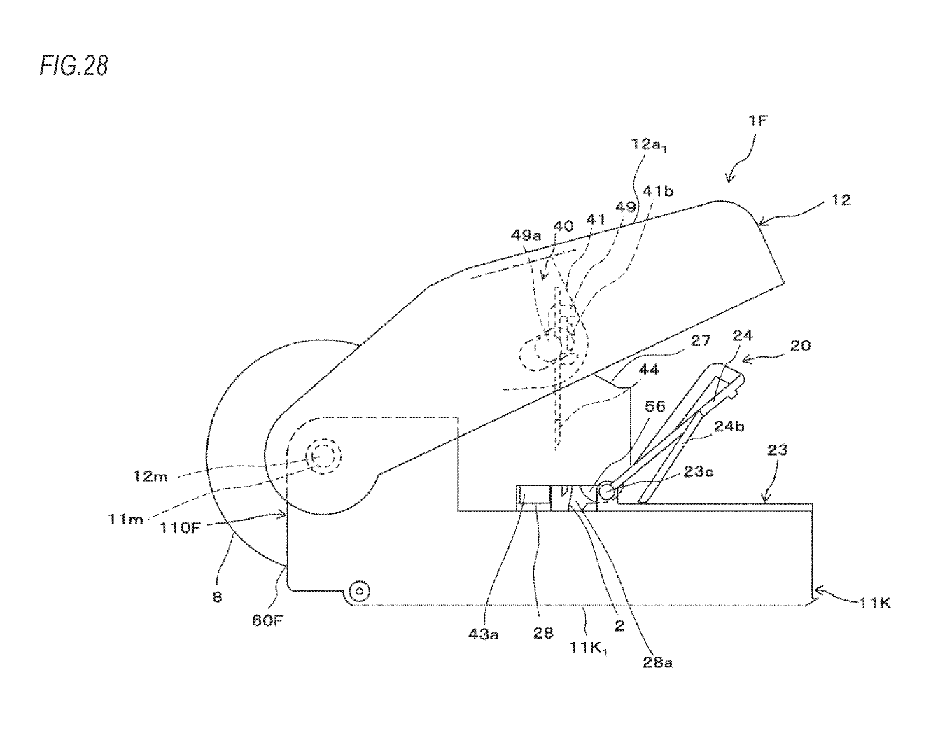

FIG. 28 is a configuration view depicting an example of a binding device in accordance with a sixth embodiment. A binding device 1F of the sixth embodiment is configured to accommodate the cassette 8 at the rear thereof. In the meantime, the equivalent configurations to the binding device 1A of the first embodiment are denoted with the same reference numerals, and the detailed descriptions thereof are omitted.

In the binding device 1F, the handle unit 12 is provided with the first gripping part 12a₁ for gripping and operating the binding device 1F. Also, a base unit 11K is provided with a second gripping part 11K₁ for gripping and operating the binding device 1F, and when operating the binding device 1F, it is possible to operate the same with gripping the first gripping part 12a₁ and the second gripping part 11K₁.

The binding device 1F has a cassette storage unit 60F, to which the cassette 8 is to be detachably mounted, at the rear of a device main body 110F having the base unit 11K and the handle unit 12.

The cassette storage unit 60F is an example of the storage unit and is provided at a part of the device main body 110F, which is at the rear of the first gripping part 12a₁ of the handle unit 12 or the second gripping part 11k₁ of the base unit 11K, in the sixth embodiment, at the rear of the base unit 11K.

In the binding device 1F, the cassette 8 is attached to the rear of the device main body 110F, so that it is possible to suppress the size in the height direction. Thereby, the degree of freedom of the shape of the base unit 11K increases, so that it is possible to make a shape suitable for the gripping.

### Configuration Example of Binding Device of Seventh Embodiment

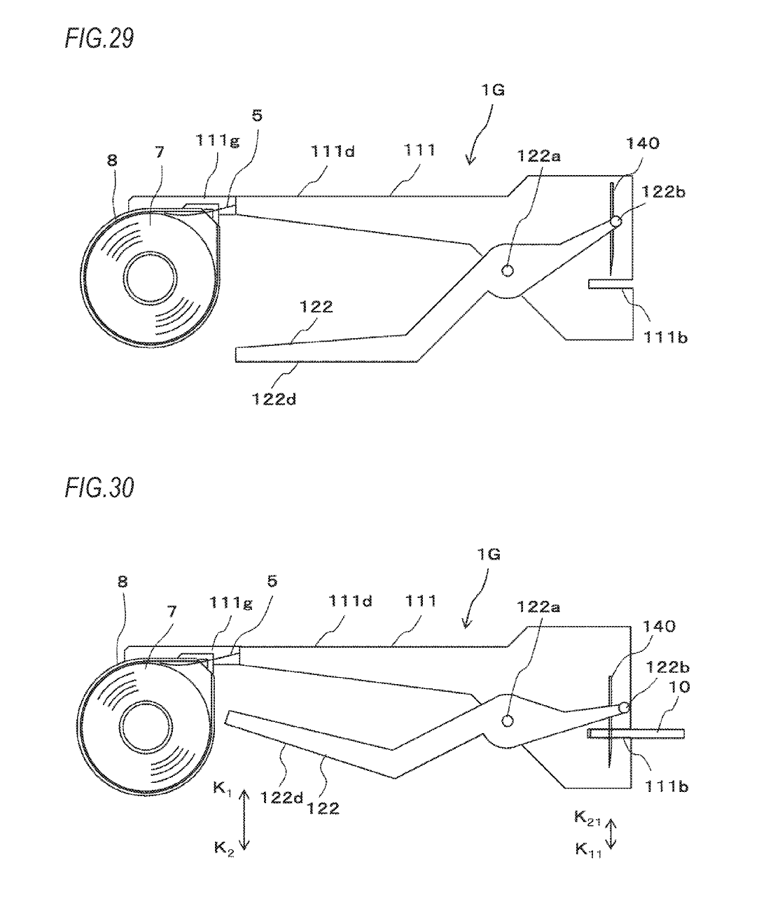

FIGS. 29 and 30 are configuration views depicting an example of a binding device in accordance with a seventh embodiment. In the meantime, the equivalent configurations to the binding device 1D of the fourth embodiment are denoted with the same reference numerals, and the detailed descriptions thereof are omitted.

In a binding device 1G, the handle unit 122 is provided with the first gripping part 122d for gripping and operating the binding device 1G. Also, the base unit 111 is provided with the second gripping part 111d for gripping and operating the binding device 1G, and when operating the binding device 1G, it is possible to operate the same with gripping the first gripping part 122d and the second gripping part 111d.

A cassette storage unit 111g is provided at a part of the base unit 111, which is at the rear of the second gripping part 111d.

In the binding device 1G, the cassette 8 is attached to a position at the rear of the device, at which the gripping is not disturbed. Thereby, the degree of freedom of the shapes of the handle unit 122 and the base unit 111 increases. Therefore, for example, it is possible to make a shape by which it is possible to grip the device with one hand.

### Configuration Example of Binding Device of Eighth Embodiment

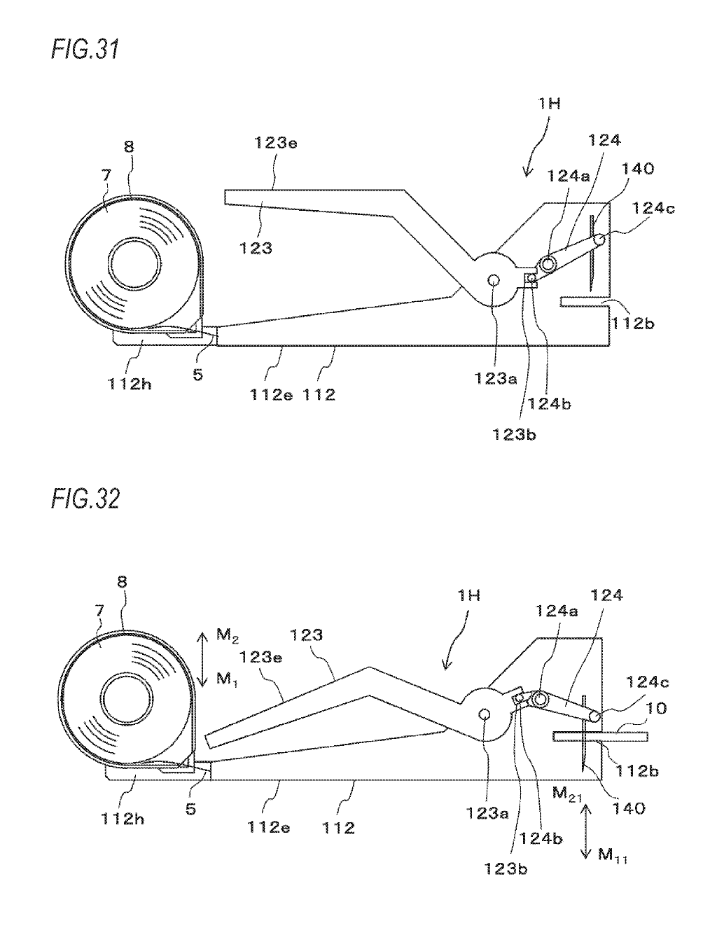

FIGS. 31 and 32 are configuration views depicting an example of a binding device in accordance with an eighth embodiment. In the meantime, the equivalent configurations to the binding device 1E of the fifth embodiment are denoted with the same reference numerals, and the detailed descriptions thereof are omitted.

In a binding device 1H, the handle unit 123 is provided with the first gripping part 123e for gripping and operating the binding device 1H. Also, the base unit 112 is provided with the second gripping part 112e for gripping and operating the binding device 1H, and when operating the binding device 1H, it is possible to operate the same with gripping the first gripping part 123e and the second gripping part 112e.

A cassette storage unit 112h is provided at a part of the base unit 111, which is at the rear of the second gripping part 112e.

In the binding device 1H, the cassette 8 is attached to a position at the rear of the device, at which the gripping is not disturbed. Thereby, the degree of freedom of the shapes of the handle unit 123 and the base unit 112 increases. Therefore, for example, it is possible to make a shape by which it is possible to grip the device with one hand.

### Modified Embodiment of Tape Accommodation Shape

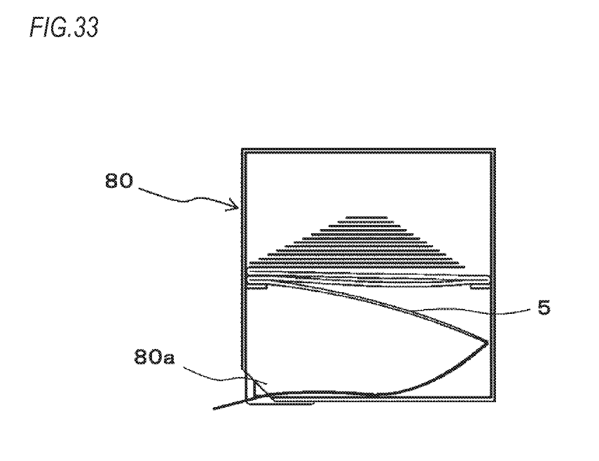

FIG. 33 illustrates a modified embodiment of the cassette. A modified embodiment of the accommodation shape of the tape 5, which is the disposable, is described. A cassette 80 has a configuration where the long tape 5 is to be accommodated with being folded in a bellows shape and is to be pulled out from the drawing port 80a. Like this, the accommodation shape of the tape 5 is not particularly limited inasmuch as it folded so that it is accommodated with a predetermined size, such as a shape wound in a roll shape, a shape folded in a bellows shape, and the like.

The subject application is based on a Japanese Patent Application No. 2014-201663 filed on Sep. 30, 2014, which is herein incorporated by reference.

### INDUSTRIAL APPLICABILITY

The present invention is applied to a device configured to bind a sheet bundle with a piece made of paper or the like.

### DESCRIPTION OF REFERENCE NUMERALS

1A to 1H . . . binding device, 2 . . . piece, 3 . . . adhesive layer, 4 . . . release paper, 5 . . . tape 6 . . . engaging hole, 7 . . . roll body, 8 . . . cassette, 10 . . . sheet bundle, 11A to 11C . . . base unit 12 . . . handle unit, 20 . . . holding unit, 40 . . . binding unit, 44 . . . cutting blade 50 . . . conveyor unit, 60A to 60C . . . cassette storage unit

1. A binding device comprising:
a device main body comprising a base unit, on which a sheet bundle is to be placed, and an operation member;
a cutting blade configured to penetrate the sheet bundle by an operation of the operation member and to insert a piece into the sheet bundle;
a storage unit configured to store therein a disposable of which a plurality of pieces is bonded to a long release paper; and
a conveying unit configured to convey the disposable pulled out from the storage unit, wherein the storage unit is provided at a part of the device main body in front of or at a rear of a gripping part of the operation member, and
wherein the storage unit is provided at a part of the device main body, which faces the cutting blade via the sheet bundle, which is to be placed on the base unit, being interposed therebetween.

2. A binding device comprising:
a device main body comprising a base unit, on which a sheet bundle is to be placed, and an operation member;
a cutting blade configured to penetrate the sheet bundle by an operation of the operation member and to insert a piece into the sheet bundle;
a storage unit configured to store therein a disposable of which a plurality of pieces is bonded to a long release paper; and
a conveying unit configured to convey the disposable pulled out from the storage unit,
wherein the storage unit is provided at a part of the device main body, which faces a gripping part of the operation member via the sheet bundle, which is to be placed on the base unit, being interposed therebetween.

3. A binding device comprising:
a device main body comprising a base unit, on which a sheet bundle is to be placed, and an operation member;
a cutting blade configured to penetrate the sheet bundle by an operation of the operation member and to insert a piece into the sheet bundle;
a storage unit configured to store therein a disposable of which a plurality of pieces is bonded to a long release paper; and
a conveying unit configured to convey the disposable pulled out from the storage unit,
wherein the storage unit is provided at a part of the device main body, which is in front of or at a rear of a first gripping part of the operation member or a second gripping part of the base part, and
wherein the storage unit is provided at a part of the device main body, which faces the cutting blade via the sheet bundle, which is to be placed on the base unit, being interposed therebetween.

4. The binding device according to claim 1, wherein the operation member is provided to be rotatable about a shaft serving as a support point relative to the base unit.

5. The binding device according to claim 2, wherein the storage unit is provided at a part of the device main body, which faces the cutting blade via the sheet bundle, which is to be placed on the base unit, being interposed therebetween.

6. The binding device according to claim 1, wherein the operation member is provided to be rotatable about a shaft serving as a support point relative to the base unit, and
wherein the storage unit is provided at a part of the device main body, which faces the shaft via the cutting blade being interposed therebetween.

7. The binding device according to claim 1, wherein the storage unit is provided at a part of the device main body, at which a part from which the disposable is to be pulled out faces the cutting blade via the conveying unit being interposed therebetween.

8. The binding device according to claim 2, wherein the storage unit is provided at a part of the device main body, which is in front of or at the rear of the gripping part of the operation member.

9. The binding device according to claim 1, wherein each piece is made of an easily bendable non-metal material having a thin foil shape.

10. The binding device according to claim 2, wherein the operation member is provided to be rotatable about a shaft serving as a support point relative to the base unit.

11. The binding device according to claim 3, wherein the operation member is provided to be rotatable about a shaft serving as a support point relative to the base unit.

12. The binding device according to claim 2, wherein each piece is made of an easily bendable non-metal material having a thin foil shape.

13. The binding device according to claim 3, wherein each piece is made of an easily bendable non-metal material having a thin foil shape.
